(19) United States
(12) Patent Application Publication
(10) Pub. No.: US 2008/0163504 A1
(43) Pub. Date: Jul. 10, 2008

(54) APPARATUS AND METHODS FOR LOCATING AND IDENTIFYING REMOTE OBJECTS

(76) Inventors: John E. Smith, Mission Viejo, CA (US); John LaBelle, Long Beach, CA (US); Brian Tingey, Fountain Valley, CA (US); John Hoot, San Clemente, CA (US); Kenneth Baun, Trabuco Canyon, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/620,631

(22) Filed: Jan. 5, 2007

(51) Int. Cl. G01C 17/34

(52) U.S. Cl. 33/268

(57) ABSTRACT

A sighting device may be used to identify and/or locate remote celestial and/or terrestrial objects. The device may include one or more gravity sensors and one or more magnetic sensors that are used to determine the direction in which the device is aimed. Once the aiming direction is determined, a device control system may be used to access an object database and determine a likely candidate object on or near the aiming direction. The device may include capability to output audiovisual information related to the object. The device may be configured to provide audiovisual commands that direct the user to point the device toward a desired or target location, thereby allowing the user to locate objects with unknown positions. The device may be used as a control system for telescopes and other optical devices.

### BACKGROUND OF THE DISCLOSURE

1. Field of the Invention

The present disclosure relates to systems and methods that assist a user in locating and identifying remote objects, including celestial and terrestrial objects.

2. Description of the Related Art

Viewing celestial objects in the night sky has been a popular pastime for thousands of years. Stars have been grouped into constellations such as Ursa Major (containing the “Big Dipper”) and Orion the Hunter, with attendant fables and stories. Different planets wander across the night sky at different times of the year. Amateur astronomers enjoy trying to locate double stars, nebulae, and galaxies.

Nighttime celestial observation presents many challenges, especially to casual or novice observers. For example, many astronomical objects are faint and hard to find in the night sky, especially in city areas having significant light pollution. Also, some astronomical objects are visible in the nighttime sky only during certain times of the year, and an object may be located in an easily viewable portion of an observer's sky for only a few hours. These challenges make it difficult for armchair or relatively novice astronomers to know when and where desirable objects are available for viewing. Additionally, an observer may see an unknown object in the evening sky and wish not only to know one or more of its name, identity, historical and astronomical lore related to the object, or the like.

Similar challenges are present if a person wishes to locate and/or identify terrestrial objects such as geological formations (e.g., mountain peaks, rivers, valleys, etc.) or other features (e.g., monuments, buildings, etc.). For example, a hiker may wish to identify and learn information related to various objects that can be seen at vantage points along a hike. However, even with an accurate map, identifying and/or locating objects can be difficult without significant experience and training.

### SUMMARY

In view of the foregoing, apparatus and methods are disclosed that enable a user to locate and/or identify remote objects including astronomical and/or terrestrial objects. In some embodiments, the apparatus includes an ergonomically designed device configured with a pistol grip and illuminated sights to permit the user to straightforwardly point toward a remote object. The user may advantageously actuate a trigger when the object is centered in the sights, and the device will seek to identify the object using, for example, a current orientation of the device and an appropriate celestial (and/or terrestrial) database of candidate objects. In some embodiments, the device may use one or more gravitational sensors and/or one or more magnetic sensors (e.g., a magnetic compass) to determine the orientation of the device. The device may provide object-related information to the user via audio and/or visual output. In other embodiments, a desired object may be input to the device (e.g., by the user or other apparatus), and the device will provide audio and/or visual commands directing the user how to point the device in order to locate the object. Such embodiments have many uses and may be attached or even retrofitted to a telescope (or other optical device) to provide a control system for directing the telescope's motion. In certain embodiments, after locating a desired object, the device can be actuated to provide suitable directional commands to the control system of a motorized telescope, which can automatically slew the telescope toward the desired object.

An embodiment of a device for identifying or locating an object is disclosed. The device comprises a housing comprising a grip and a barrel. The barrel has a pointing axis and the grip has a grip axis that is non-parallel to the pointing axis. The grip can be used to orient the pointing axis of the barrel toward an object. The device further comprises a display attached to the housing. The display is configured to provide visual output capable of being viewed by a user of the device when the device is pointed at or being pointed at the object. The device also includes one or more orientation sensors capable of providing information related to orientation, and a processor capable of receiving the information from at least one of the one or more orientation sensors and determining an orientation of the pointing axis of the barrel.

In some embodiments, the housing of the device is substantially pistol-shaped. In an embodiment, at least one of the one or more comprises a gravity sensor capable of providing information related to a reference acceleration. In one implementation, the reference acceleration may comprise the Earth's gravitational acceleration. In another embodiment, at least one of the one or more comprises a magnetic field sensor capable of providing information related to a reference magnetic field. In one implementation, the reference magnetic field may comprise the Earth's magnetic field. In some embodiments, the orientation comprises at least one of an altitude, an azimuth, and a roll angle. In an alternative embodiment, the device comprises one or more directional indicators configured to provide an audio or visual indication on how or where to move or orient the device so as to point toward the object. In some embodiments, the object is a celestial object. In alternative embodiments, the object is a terrestrial object.

An embodiment of a method of aiming a device toward an object is disclosed. The method comprises providing a device that comprises a housing comprising a grip and a barrel. The barrel has a pointing axis, and the grip has a grip axis that is non-parallel to the pointing axis. The device also comprises a sight having an aiming axis that is substantially parallel to the pointing axis and a display attached to the housing. The device further includes one or more orientation sensors capable of providing information related to orientation, and a processor capable of receiving the information from at least one of the one or more orientation sensors and determining an orientation of the pointing axis or the aiming axis. The method further comprises pointing the aiming axis of the sight substantially toward the object, and actuating the processor to determine an orientation direction of the pointing axis or the aiming axis.

In certain embodiments, the method further comprises providing an object database comprising location information for one or more candidate objects and comparing the orientation direction to the location information. In certain such embodiments, the method further comprises identifying one or more candidate objects having a location substantially along the orientation direction. In an embodiment, the object is a celestial object. In another embodiment, the object is a terrestrial object.

An embodiment of a method of locating a target object is disclosed. The method comprises providing a device that comprises a housing comprising a grip and a barrel. The barrel has a pointing axis, and the grip has a grip axis that is non-parallel to the pointing axis. The device also comprises a sight having an aiming axis that is substantially parallel to the pointing axis and a display attached to the housing. The device further includes one or more orientation sensors capable of providing information related to orientation, and a processor capable of receiving the information from at least one of the one or more orientation sensors and determining an orientation of the pointing axis or the aiming axis. The method further comprises providing to the device location information for the target object and determining, by the device, a current orientation direction of the pointing axis. The method also includes determining, by the device, a path from the current orientation direction to the orientation of the target object determined from the location information. In an embodiment, the method also comprises actuating one or more directional indicators that provide information capable of enabling a user to move or orient the device so that the pointing axis is directed toward the target object. In an embodiment, the target object is a celestial object. In another embodiment, the target object is a terrestrial object.

An embodiment of a sighting device comprises housing means comprising means for sighting toward an object and means for gripping the sighting device. The sighting means are disposed nonparallel to the gripping means. The sighting device also comprises means for outputting visual information, the outputting means attached to the housing means and means for sensing orientation. The device further comprises means for processing information from the sensing means to determine an orientation of the sighting device.

An embodiment of a sighting device comprises a housing, a display attached to the housing, and one or more orientation sensors capable of providing orientation information. The device comprises a processor that is capable receiving the orientation information and determining an orientation of the device. The device further comprises a power source that is substantially magnetically shielded from at least one of the one or more orientation sensors.

In some embodiments, the power source is sufficiently spaced apart from the at least one of the one or more orientation sensors to provide substantial magnetic shielding. In another embodiment, magnetic shielding material having reasonably high magnetic permeability is disposed between or around the power source. In certain embodiments, the housing comprises a grip and a barrel, with the grip having a grip axis that is nonparallel to a pointing axis of the barrel. In certain such embodiments, the power source is disposed in the grip. In an alternative embodiment, the housing further comprises a base disposed toward a bottom end of the grip. In some of these embodiments, the power source is disposed in the base. In one implementation, magnetic shielding material having a reasonable high magnetic permeability may be disposed around the power source. In one embodiment, the at least one of the one or more orientation sensors is disposed toward a forward end of the barrel and physical separation between this orientation sensor and the power source in the base provides substantial magnetic shielding. In an embodiment, the power source comprises one or more batteries. In some embodiments, the at least one of the one or more orientation sensors comprises a magnetic sensor.

An embodiment of a remote viewing device comprises one or more orientation sensors capable of providing orientation information. The device comprises a processor that is capable receiving the orientation information and determining an orientation direction of the device. The processor is configured to communicate the orientation direction to a control system configured to direct movement or orientation of an optical system having an optical axis. In response to the communicated orientation direction, the control system is configured to move or orient the optical axis toward the orientation direction. In one embodiment, the remote viewing device comprises a housing including a grip having a grip axis and a barrel having a barrel axis. In some embodiments, the grip axis is nonparallel to the barrel axis. In certain embodiments, the control system is configured to communicate an orientation direction of the optical axis of the optical system to the remote viewing device. In some embodiments, the optical system comprises a telescope, and the control system comprises a telescope control system.

An embodiment of a method of using a sighting device to direct the orientation of an optical system having an optical axis is disclosed. The sighting device comprises a housing having a pointing axis, a display attached to the housing, and one or more orientation sensors capable of providing orientation information. The sighting device further comprises a processor configured to use the orientation information to determine an orientation direction of the pointing axis. The method comprises aiming the sighting device toward a target object and actuating the processor to determine the orientation direction of the target object. The method further comprises communicating information related to the orientation direction to a control system capable of moving or orienting the optical axis of the optical system. In some embodiments, the optical system comprises a telescope.

An alternative embodiment of a method of directing a sighting device to toward a target object is disclosed. The sighting device comprises a housing having a pointing axis, a display attached to the housing, and one or more orientation sensors capable of providing orientation information. The sighting device further comprises a processor configured to use the orientation information to determine an orientation direction of the pointing axis. The sighting device also comprises an input module capable of receiving location information for a target object. The method comprises aiming an optical system toward a target object. The optical system comprises a communications module configured to communicate an orientation direction of the optical system to a sighting device. The method further comprises communicating information related to the orientation direction of the target object to the sighting device. The method also includes actuating, by the sighting device, one or more directional indicators providing information capable of permitting a user to move or orient the sighting device toward the target object. In some embodiments, the optical system comprises a telescope. In an embodiment, the target object is a celestial object. In another embodiment, the target object is a terrestrial object.

In another embodiment, a method of using a sighting device to direct the orientation of an optical system having an optical axis toward a target object is disclosed. The sighting device comprises a housing having a pointing axis, a display attached to the housing, and one or more orientation sensors capable of providing orientation information. The sighting device further comprises a processor configured to use the orientation information to determine an orientation direction of the pointing axis. The sighting device also includes one or more directional indicators. The sighting device is configured to actuate the directional indicators to indicate to a user how or where to move or orient the orientation direction of the pointing axis so that it points toward the target object. The method comprises aligning the pointing axis of the sighting device substantially parallel to the optical axis of the optical system. The method further comprises providing location information for the target object to the sighting device and actuating the processor to determine the orientation direction of the pointing axis. The method also includes actuating the directional indicators to indicate how to move or orient the optical axis or the pointing axis toward the location of the target object. In some embodiments, the optical system comprises a telescope. In certain embodiments, the optical system comprises one or more drive motors configured to move or orient the optical axis. In certain such embodiments, the method further comprises communicating information from the sighting device to the one or more drive motors to cause movement or orientation of the optical axis toward the location of the target object. In an embodiment, the target object is a celestial object. In another embodiment, the target object is a terrestrial object.

In an embodiment, a sighting device comprises a housing having a pointing axis, a magnetic sensor capable of providing a measurement of at least one component of a local magnetic field, and a processor capable of using the measurement to determine an orientation of the sighting device. In certain embodiments, the orientation comprises a roll angle about the pointing axis of the device. In some embodiments, the magnetic sensor is capable of providing a measurement of at least two components of the local magnetic field. In other embodiments, the magnetic sensor is capable of providing a measurement of three components of the local magnetic field. In an alternative embodiment, the orientation comprises an azimuth angle of the pointing direction relative to a reference direction of the local magnetic field. In another embodiment, the orientation comprises an altitude of the pointing direction relative to a reference direction of the local magnetic field. In certain embodiments, the processor is capable of using information related to the local magnetic field to determine orientation of the pointing direction relative to a second reference direction. In some implementations, the local magnetic field comprises the Earth's magnetic field. In an embodiment, the second reference direction is geographic North.

### BRIEF DESCRIPTION OF THE DRAWINGS

FIGS. 1A and 1B are perspective views schematically illustrating a left side (FIG. 1A) and a right side (FIG. 1B) of an embodiment of a sighting device.

FIGS. 2A and 2B are plan views schematically illustrating the left side (FIG. 2A) and the right side (FIG. 2B) of the sighting device shown in FIGS. 1A and 1B.

FIGS. 3A and 3B are plan views schematically illustrating a front (FIG. 3A) and a rear (FIG. 3B) of the sighting device shown in FIGS. 1A and 1B.

FIGS. 4A and 4B are plan views schematically illustrating a top (FIG. 4A) and a bottom (FIG. 4B) of the sighting device shown in FIGS. 1A and 1B.

FIG. 5 is an example exploded view schematically illustrating an embodiment of the sighting device shown in the preceding figures.

FIG. 6 is an example block diagram schematically illustrating a control system in an embodiment of a sighting device.

FIG. 7A schematically illustrates angular coordinates (altitude, azimuth, and roll) suitable for determining an orientation of a sighting device.

FIG. 7B schematically illustrates roll indicators that assist the user in levelly holding a sighting device.

FIG. 8 is a flowchart schematically illustrating an example process flow for estimating whether nearby ferromagnetic material and/or electromagnetic devices are distorting the local geomagnetic field.

FIGS. 9A-9B are flowcharts schematically illustrating example process flows that may be used to calibrate a gravity sensor (FIG. 9A) and a magnetic sensor (FIG. 9B) of the sighting device, according to an embodiment of the disclosure.

FIG. 10 is an example schematic illustration of a user aiming a sighting device toward a celestial object.

FIG. 11 is a flowchart schematically illustrating one example method for identifying a celestial object with a sighting device.

FIG. 12 is a flowchart schematically illustrating another example method for locating a celestial object with a sighting device.

FIG. 13 is a rear view of a sighting device schematically illustrating pointing indicators that may be used to direct the device toward an object.

FIG. 14 is a flowchart schematically illustrating an example method for identifying remote terrestrial objects with the device.

FIG. 15 is a perspective view of a sighting device used as a controller for a telescope system.

### DETAILED DESCRIPTION OF PREFERRED EMBODIMENTS

Certain embodiments of the disclosure are described herein with reference to the figures. These embodiments are intended to illustrate various aspects and advantages of the disclosure herein and are not intended to limit the scope of the disclosure. It is to be understood that not every embodiment need achieve each of the aspects and advantages described herein. For example, an embodiment may be adapted to achieve or optimize one advantage, or a group of advantages, without necessarily achieving or optimizing other advantages. Further, various methods are described herein, and it is to be understood that the acts in a particular embodiment of a method may be performed in any suitable order unless a particular order is expressly stated. Additionally, it is to be understood that embodiments of the methods can utilize additional and/or different acts and that one or more acts may be combined, grouped, and/or performed differently than described.

In general terms, embodiments of the present disclosure include a sighting device that can be used to identify and/or locate remote objects. The device may advantageously comprise one or more gravity sensors and one or more magnetic sensors that are used to determine the direction in which the device is aimed. For example, the gravity sensors may be used to determine how far above (or below) the horizon the device is pointed. The magnetic sensors can act as a compass and may be used to determine the direction of the device with respect to North. In an embodiment, the device's control system can access an object database and determine a likely candidate object in the current pointing direction. The device may include capability to output audiovisual information related to the object. For example, a user may point the device toward a bright object in the nighttime sky. The device may determine that the object is likely to be the planet Jupiter and then output images and videos related to Jupiter.

Embodiments of the device can also be used to locate remote objects. For example, a user may wish to know where the planet Jupiter is in the night sky. Again in general terms, the user can input the name (or other identifying characteristic) of the desired object into the device (e.g., via a keypad). The device can determine the position of the object in the sky viewable from the user's location. The device can then output audio and/or visual commands directing the user to move the device so as to point toward the object. For example, the device may display directional indicators (e.g., arrows and/or lights) showing the user a direction to move (or otherwise orient) the device.

By providing the device with position information for terrestrial objects (e.g., geological features, buildings, monuments, etc.), the device can be similarly used to identify and/or locate terrestrial objects. Other uses are possible. For example, embodiments of the device advantageously can be used as a control system for an optical device such as a telescope. These and other embodiments and uses will now be described.

### Sighting Device

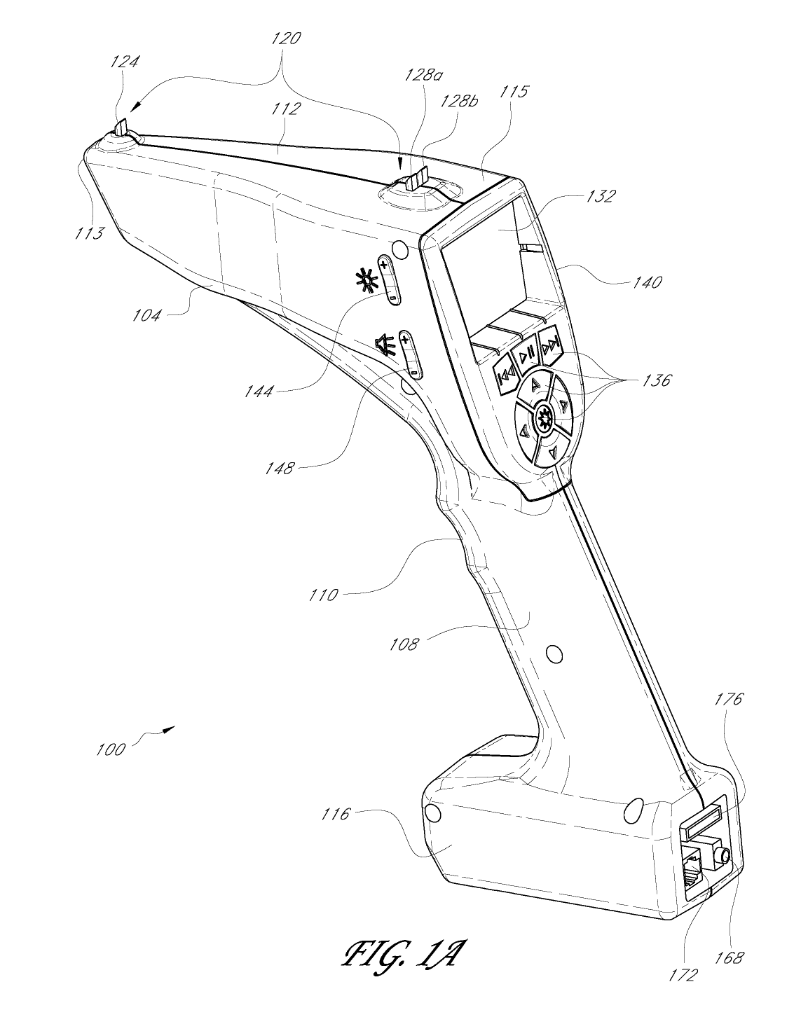

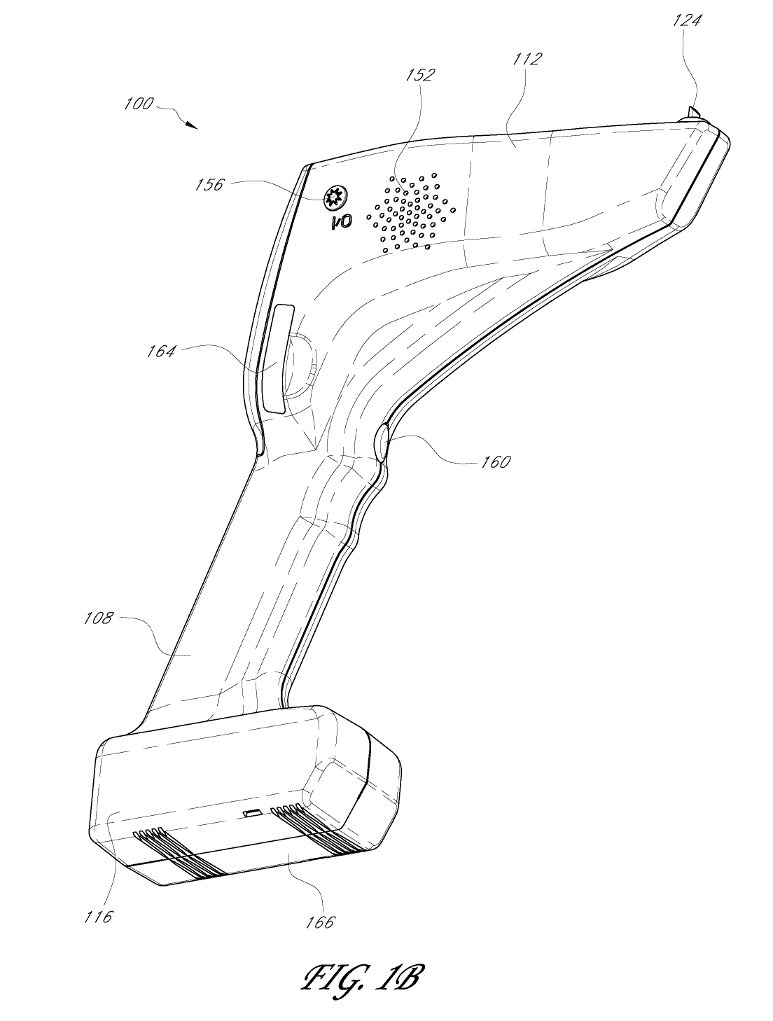

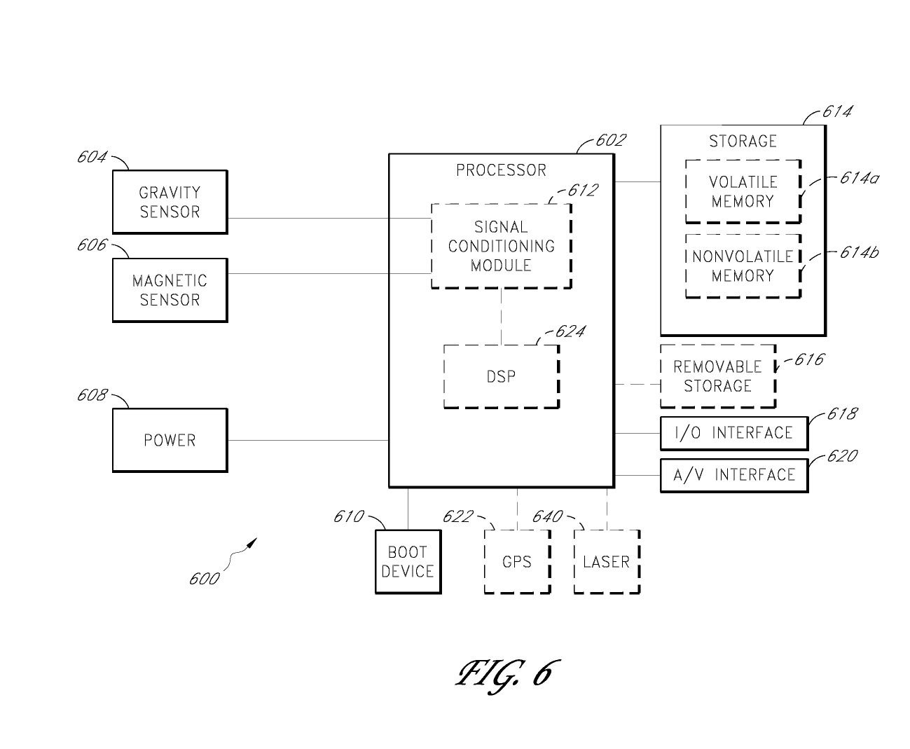

FIGS. 1A and 1B are perspective views that schematically illustrate an embodiment of a sighting device 100, which may be used to identify and/or locate remote objects. FIG. 1A shows a left side and FIG. 1B shows a right side of the device 100. The device 100 comprises a housing 104 in which the internal electronics, sensors, and power supplies are disposed. The housing 104 may be fabricated from a lightweight, durable material such as plastic or metal. The housing 104 advantageously should be sufficiently sturdy to protect the internal components if the device 100 is dropped, which is not unlikely during late-night use by an observer. The housing 104 may comprise one or more pieces that are coupled together (see, e.g., FIG. 5) by, for example, fasteners, glue, welds, etc.

In the embodiment shown in FIGS. 1A and 1B, the housing 104 is formed in a “pistol” configuration comprising a grip 108, a barrel 112, and a base 116. The grip 108 connects the base 116 and the barrel 112, and is sized and shaped to be held in a single hand of the user, although a dual hand grip could also be implemented. The grip 108 may comprise features 110 such as, for example, indentations, grooves, scallops, ridges, etc. for the user's fingers. The barrel 112 has a forward end 113 and a rear end 115. As described further below, the grip 108 and the barrel 112 form an angle therebetween that makes it easy for the user to point the forward end 113 of the barrel 112 toward a remote object. The base 116 is disposed toward the bottom of the grip 108 and may be configured to hold a power source (e.g., batteries) for the device 100. The base 116 comprises a cover 166 that can be opened to permit insertion/removal of the batteries. The base 116 advantageously may have sufficient weight that the device 100 is comfortably balanced when held by the user. Additionally, the device 100 may be configured so that it can stand upright when the base 116 is placed on a flat surface.

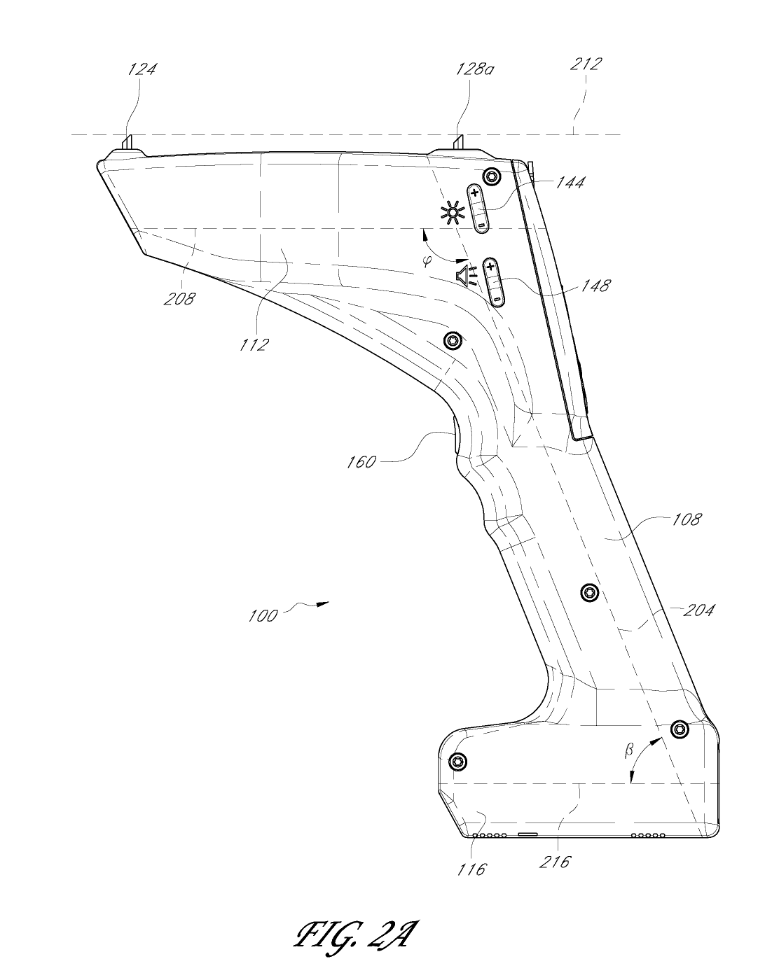

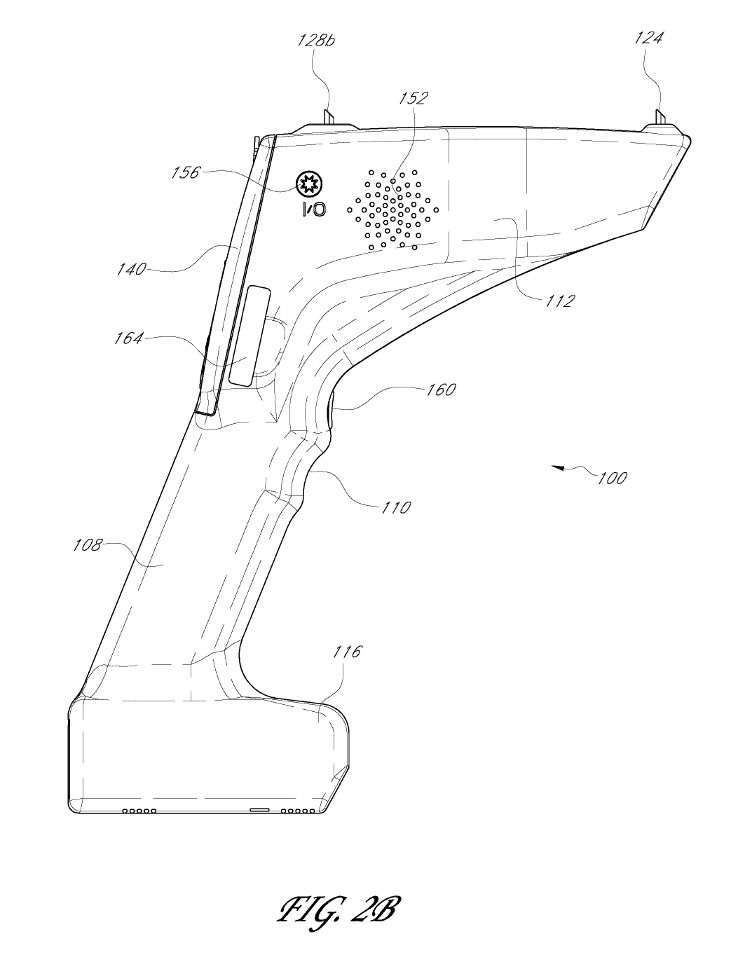

A sight 120 may be disposed on or near the barrel 112 of the device 100 to permit more precise aiming. The sight 120 may comprise an aiming tube, aiming markers (e.g., similar to iron sights on a gun), an optical sight (such as a rifle-sight), or other suitable aiming device. The sight 120 may provide optical magnification and optionally may include a reticle, cross-hairs, or other targeting indicia (which may be illuminated). The sight 120 may be user-adjustable to permit more precise object targeting. In the embodiment shown in FIGS. 1A and 1B, the sight 120 comprises a forward sight 124 and a rearward sight 128. The forward sight 124 is disposed at or near the forward end 113 of the barrel 112 and is spaced apart from the rearward sight 128, which is disposed at or near the rear end 115 of the barrel 112. The forward and rearward sights 124 and 128 are disposed along an aiming axis 212 (best seen in FIG. 2A). In this embodiment, the rearward sight 128 comprises two aim indicators 128a, 128b spaced apart transverse to the aiming axis 212 such that the forward sight 124 can be viewed between the indicators 128a, 128b when the barrel 112 of the device 100 is pointed at the target object. In other embodiments, the rearward sight 128 comprises a single aim indicator having a U- or V-shaped groove or notch. In some embodiments, the rearward sight 128 comprises an aperture or ring. The forward and/or rearward sights 124 128 advantageously may be illuminated for night use as further described below. A skilled artisan will recognize that the sights 124 and 128 can be used on other apparatus than the sighting device 100. Moreover, an artisan will recognize that a wide range of aiming apparatus and method can be used to point the device 100.

It is advantageous if the device 100 is configured to be ergonomic, easy to hold and use, and sufficiently lightweight to prevent fatigue. For example, the device 100 may be sufficiently small to be easily portable yet large enough to fit comfortably in a typical user's hand. The housing 104 (or portions thereof) may be made from (or covered by) a rubberized material that allows the user a good grip on the device 100. The device 100 beneficially should be sufficiently lightweight that an observer can use one hand (if desired) to hold and aim the device 100. Additionally, embodiments of the device 100 may be light enough that the observer can, if desired, hold the device 100 at arm's length while sighting remote objects.

The sighting device 100 may comprise one or more audio and/or visual input/output (I/O) components and controls. The device 100 may comprise a display 132 capable of displaying, for example, text, numeric or graphic output, images and/or videos. In the embodiment shown in FIGS. 1A and 1B, the display 132 is disposed at the rear end 115 of the barrel 112 of the device 100, which advantageously allows the user to easily view the display 132 when the barrel 112 is pointed toward an object. In certain embodiments, the display 132 is disposed at a side of the device 100 and may be configured to fold toward the device 100 when not in use. In some embodiments, the device 100 does not include a display 132. Other embodiments may output visual information via one or more lights such as, e.g., light-emitting diodes (LEDs). A combination of visual output device may be used.

The display 132 may output user prompts, queries, instructions, messages, and combinations thereof The display 132 may be monochrome, grayscale, or color. The display 132 may comprise a flat-panel display including, but not limited to, a liquid crystal display (LCD), a plasma display, a microelectromechanical systems (MEMS) display, or a digital light processing (DLP) display. The display 132 advantageously may have a resolution sufficient to output reasonably high quality images, graphics, and videos. For example, in some embodiments the display 132 comprises a color LCD with a resolution of 160×234 pixels. In other embodiments, other horizontal and/or vertical resolutions are used. The display 132 may be sufficiently large for anyone nearby the user to view visual output. In other embodiments, the display 132 comprises a touchscreen that enables a user to input data by touching portions of the touchscreen. An artisan will also recognize from the disclosure herein that the display 132 may comprise any suitable output and/or input device capable of providing information to and/or from a user, including, for example, a separate computing device such as a handheld device, a laptop, a desktop or other computing devices communicating over wired and/or wireless mediums.

The device 100 may include controls (e.g., brightness control 144) for adjusting the brightness, contrast, output colors, or other properties of the display 132. In some embodiments, the display 132 is configured to provide output predominantly in the color red to reduce impact on the night adaptation of the user's eyes. For example, a filter that transmits predominantly red light may be disposed adjacent the display 132 to filter the generally white light output from the display 132 so that predominantly red light reaches the user's eyes. In other embodiments, the colors of the display 132 may be electronically adjusted to output shades of red.

The device 100 shown in FIGS. 1A and 1B includes keys 136 that can be used to enter data and commands as well as to navigate (e.g., scroll) among menus in the display 132. The keys 136 can include buttons and/or an alphanumeric keyboard or keypad. In some embodiments, a user can additionally or alternatively use touch sensitive areas on a touchscreen display to perform input operations. The keys 136 advantageously may be disposed so that the user can actuate one or more of the keys 136 with the thumb on the hand holding the device 100. Other input devices can be used. The keys 136 may be used to enter user information including, for example, local time and date and geographic location (e.g., longitude and latitude or nearby city). The keys 136 may include buttons or keys for controlling the output and operation of images or videos shown on the display 132. For example, the keys 136 may include play/pause, fast forward, and reverse. An “Enter” key may be used to select commands from on-screen menus. In some embodiments, the device 100 comprises a microphone through which the user can provide audible input. Electronic circuitry in the device 100 can include an executable voice or speech recognition program to convert audible voice input into suitable device commands.

The display 132 and/or keys 136 can be substantially surrounded by (or embedded in) a display housing 140. As shown in FIG. 1A, the display 132 may be protected from accidental scratches by being recessed in the display housing 140. The display housing 140 may be fabricated from a resilient, elastomeric material that will protect the display 132 and keys 136 if the device 100 is dropped.

In some embodiments, the display 132 is angled in the housing 140 so that the display 132 is substantially perpendicular to the user's line-of-sight when the device 100 is aimed at an object. These embodiments beneficially provide improved viewing of the display 132, especially for LCD screens whose contrast and brightness fall off relatively steeply as viewing angle increases.

The device 100 can provide audio output via one or more speakers 152 (FIG. 1B), which can be controlled with a volume control 148. A stereo headphone jack 168 enables a user to listen to output from the device 100 without disturbing other observers nearby.

As shown in FIG. 1A, the device 100 can have additional I/O ports including, for example, an RS-232 standard serial port 172 and/or a universal serial bus (USB) port 176. Many other types of ports known in the art (e.g., an IEEE 1394 port) can be provided in other embodiments. These I/O ports can be used to couple the device 100 to peripheral devices such as, for example, a computer, a cell phone, a personal digital assistant (PDA), a pocket PC, a portable media player (e.g., an Apple® iPod®), a portable e-mail system (e.g., a Blackberry®), a data storage device, a digital camera, a printer, etc. The I/O ports may be used to connect the device 100 to a local- and/or wide-area network, the Internet, or other suitable data network. The device 100 may also be configured to communicate with a telescope control system capable of controlling the orientation of a telescope (or other optical device) with respect to the celestial sphere (e.g., by slewing axis drive motors in an altitude-azimuth or equatorial mount). For example, the device 100 may communicate orientation information to the telescope control system, which causes the telescope to slew to the object at which the device 100 is aimed. Alternatively or additionally, the telescope control system may communicate orientation information related to the device 100, which provides output (e.g., via the display 132 or the speaker 152) to direct the device's user toward an object. Telescope control systems that may be used with the device 100 include, for example, the Autostar and Autostar II Telescope Controllers available from Meade Instruments Corporation of Irvine, Calif. (Meade). Telescope control system software suitable for use with the device 100 includes, for example, the Autostar Suite, also available from Meade.

Although various wired ports and connections have been described, certain embodiments of the device 100 provide wireless communication capability. In certain such embodiments, radio frequency (RF) communication techniques are used, although other methods (e.g., infrared) are possible. For example, the device 100 may be configured to wirelessly communicate at an RF frequency of about 2.4 GHz on a wireless local area network (WLAN) or a wireless personal area network (PAN) using one (or more) of the IEEE 802.11 and/or 802.15 standards (e.g., Wi-Fi® and/or Bluetooth®). The device 100 may use wireless access to provide connectivity to the Internet (or other data network). The device 100 may be configured to wirelessly communicate with a handheld telescope control apparatus used to control a telescope (or other optical device). As described above, either the device 100 or the control apparatus can act as the “master” and communicate location and/or pointing signals (or other suitable information) to the other device, which acts as the “slave.” A wireless telescope control system suitable for use with the device 100 is described in U.S. patent application Ser. No. 11/333,423, filed Jan. 17, 2006, entitled “WIRELESS SYSTEMS AND METHODS FOR CONTROLLING A TELESCOPE,” which is hereby incorporated by reference herein in its entirety.

As shown in FIG. 1B, the device 100 can be turned on or off via the switch 156. The device 100 includes a 160, which permits the user to easily activate a variety of functions performable by the device. For example, after aiming the device 100 at an object of interest (e.g., by lining up the object in the sights 124, 128), the user can press the trigger 160 once (“single click”) to have the device 100 identify the object. Methods by which the device 100 identifies (and/or locates) objects are described below. Information related to the identified object (name, celestial coordinates, properties) can be shown on the display 132. Optionally, images and videos related to the object can be played by, for example, further pressing the trigger 160 or by actuating one of the keys 136 (e.g., a “play” key). A further press of the trigger 160 can stop display of the video or images (alternately, a “stop” key can be depressed).

The trigger 160 advantageously may be disposed on the grip 108 so that it may be actuated by a finger (e.g., an index finger) on the hand used to hold the device 100. As discussed above, certain embodiments dispose an input device (e.g., the keys 136) so they are actuatable by a thumb of the user. Accordingly, such embodiments provide one-handed operation of the device 100. Although a single trigger 160 is depicted in FIG. 1B, the device 100 may include additional triggers, buttons, keys, touch sensitive areas, or user-actuatable input elements that permit the user to enter commands, start (and/or stop) device functionality, respond to device queries, etc. Further, the trigger 160 may be disposed on elsewhere on the device 100, e.g., on a side of the housing 104.

In some embodiments, after aiming the device 100 at an object, the user can press the trigger 160 twice quickly in succession (“double click”) to activate other functionality. For example, in one embodiment, double clicking causes the device 100 to communicate orientation information to a telescope control system, which activates drive motors to slew the telescope toward the object. As described above, orientation signals can be communicated via wired or wireless techniques. In some embodiments particularly suited for telescopes having axis motors with fast slew rates, the sighting device 100 continuously communicates orientation signals to the telescope control system, thereby causing the telescope to point wherever the device 100 is aimed.

The device may include a port 164 for a nonvolatile memory card such as a flash memory card. The memory card port 164 can be adapted to accept one or more card formats including, for example, secure digital (SD), compact flash (CF), smart media (SM), memory stick (MS), extreme digital (xD), or any other suitable standard.

A device 100 having a nonvolatile memory card port 164 may have several advantages. For example, a memory card can be used to deliver software updates and upgrades to the device's internal electronic circuitry (e.g., processor and/or memory). The card can be used to update various databases stored by the device 100 (e.g., a celestial and/or terrestrial object database). A history of the objects the user has located can be stored on the card, thereby enabling the user to “reenact” his or her nighttime observations at a later time or for a different group of observers. Since memory cards are portable, they can be inserted in other devices for downloading observing data (e.g., for archival purposes). Memory cards can be formatted with informational, instructional, educational, and or entertainment data related to celestial objects. This data can include audiovisual multimedia information (images, movies, speech), which can be accessed before, during, or after observing various sky objects. For example, a user may utilize the device 100 to locate the planet Saturn and then to play a movie showing images of the planet and describing the history of the planet as well as the space missions (Pioneer, Voyager, Cassini-Huygens) to the planet. The memory card can include a “sky tour” that directs the user to a variety of interesting objects locatable in the user's nighttime sky and, optionally, plays interesting information about the object on the display 132 and/or speaker 152. As discussed above, in some embodiments, multimedia content can be accessed by pointing the device 100 toward an object and pressing the trigger 160.

FIGS. 2A-4B schematically illustrate additional views of the sighting device shown in FIGS. 1A and 1B. In these figures, like reference numerals indicate like components or aspects of the device 100.

FIGS. 2A and 2B are views of the left side and right side, respectively, of the device 100, in which the ergonomic, pistol-like configuration of the device 100 is readily seen. The grip 108 provides a comfortable handle for grasping the device 100 when in use. As described above, the grip 108 may include one or more features 110 such as finger wells to improve comfort. The grip 108 is a generally elongated body having a longitudinal axis 204. The barrel 112 is also generally elongated (defining longitudinal axis 208) and is pointed toward the object when the device 100 is in use. The sight 120 is disposed on a top portion of the barrel 112. The forward and rearward sights 124 and 128 define an aiming axis 212 that preferably is parallel to (but displaced from) the longitudinal barrel axis 208.

The longitudinal grip axis 204 makes an angle (p with respect to longitudinal barrel axis 208. In some embodiments, the angle (p is an obtuse angle (greater than 90 degrees and less than or equal to 180 degrees). In a preferred embodiment, the angle φ is in a range from about 100 degrees to about 130 degrees, which may provide for better comfort when the device 100 is held in one hand away from the body. In certain embodiments, the angle φ is about 90 degrees (e.g., the barrel 112 and the grip 108 are substantially perpendicular). In other embodiments, the angle φ is in a range from about 110 degrees to about 120 degrees

In the embodiment shown in FIGS. 1A-2B, the base 116 is an elongated body disposed at a bottom end of the grip 108. The base 116 may be used to store the power source used to provide power to the electronic circuitry in the device 100. The power source may be accessible (and/or removable) through the cover 166. The power source may comprise any suitable source of electric power. In some embodiments, electrochemical power sources such as, for example, batteries and/or fuel cells are used. For example, the power source can include disposable or rechargeable batteries (e.g., alkaline, lithium ion, nickel metal hydride). In some embodiments, the device 116 includes an AC-DC power adaptor to enable the device to run off household, alternating current or to permit recharging an internal power source (e.g., rechargeable batteries). In one embodiment, the base 116 has a size sufficient to hold four “AA” batteries. Some embodiments of the device 100 do not include a base 116. In these embodiments, the power source (e.g., one or more batteries) may be stored in the grip 108. An artisan will recognize from the disclosure herein a wide variety of powering schemes and devices capable of implementation with the device 100.

The base 116 may be an elongated body having a longitudinal axis 216. The longitudinal grip axis 208 makes an angle β with the longitudinal base axis 216. As shown in FIG. 2A, the angle β may be an acute angle (less than 90 degrees). In other embodiments, the angle β is about 90 degrees. In certain embodiments, the device 100 may be configured so that the angles φ and/or β are adjustable (within suitable ranges) to provide further ergonomic benefits for users. For example, the grip 108 may be pivotably attached to the barrel 112 and configured to be secured (e.g., by tightening a fastener) when a comfortable angle φ is achieved.

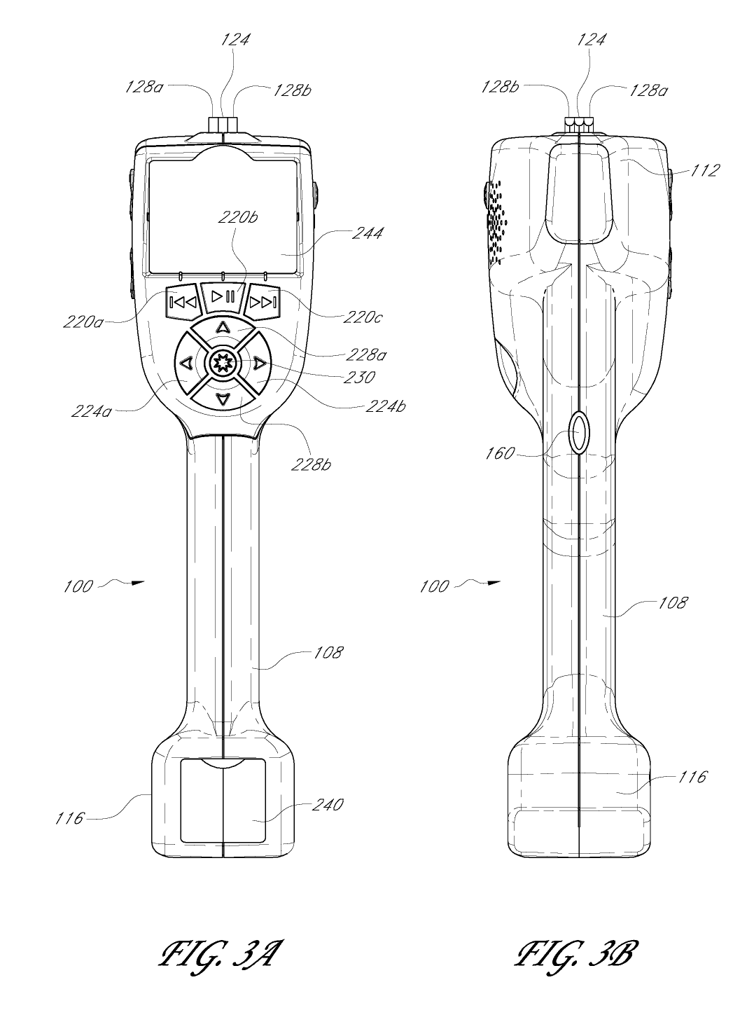

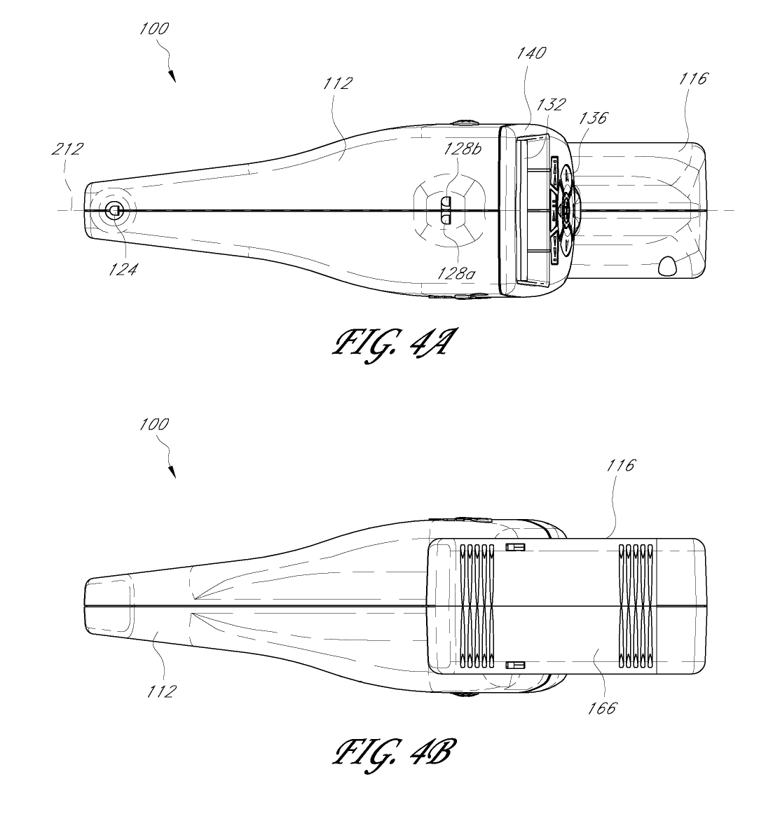

FIGS. 3A and 3B are front and rear views, respectively, of the device 100. The display 132 and keys 136 are best seen in FIG. 3B, which schematically illustrates the view from the user's perspective when the device is in use. In this embodiment, a red filter 244 is disposed adjacent the display 132 and along the line-of-sight to the user's eyes to reduce the effects of non-red light on the user's night adaptation. The red filter 244 is slidably removable if not desired. The keys 136 comprise multimedia playback keys 220a-220c, with key 220a providing “rewind,” key 220b providing “play/pause,” and key 220c providing “fast forward.” Keys 136 also comprise navigation keys 224a-230 to direct movement of a cursor on the display 132. The keys 224a, 224b move the cursor left, right, and the keys 228a, 228b move the cursor up, down. The key 230 is an “enter” or “select” button that a user pushes to actuate a menu selection on the display 132. In other embodiments, different sets of keys may be used. For example, in one embodiment, a “QWERTY” keypad is used. In other embodiments, a separate input device is used. For example, a cell phone, PDA, and/or computer may be used to communicate data and commands to the device via wired and/or wireless techniques. An artisan will recognize from the disclosure herein that the device 100 is capable of use with a wide range of input apparatus.

FIG. 3B illustrates the appearance of the sight 120 to the user when the device 100 is pointed toward an object. When properly aimed, the forward sight 124 appears to be substantially centered between the left 128a and the right 128b aim indicators, and the top of the forward sight 124 is substantially even with (or parallel to) the tops of the aim indicators 128a, 128b. Additionally, when the device 100 is properly aimed, the display 132 shown in FIG. 3B is oriented substantially perpendicularly to the user's line-of-sight, which provides improved visibility of the display 132. FIG. 3B also shows an optional cover 240 that can be used to cover the I/O ports 168, 172, and 176 when not in use.

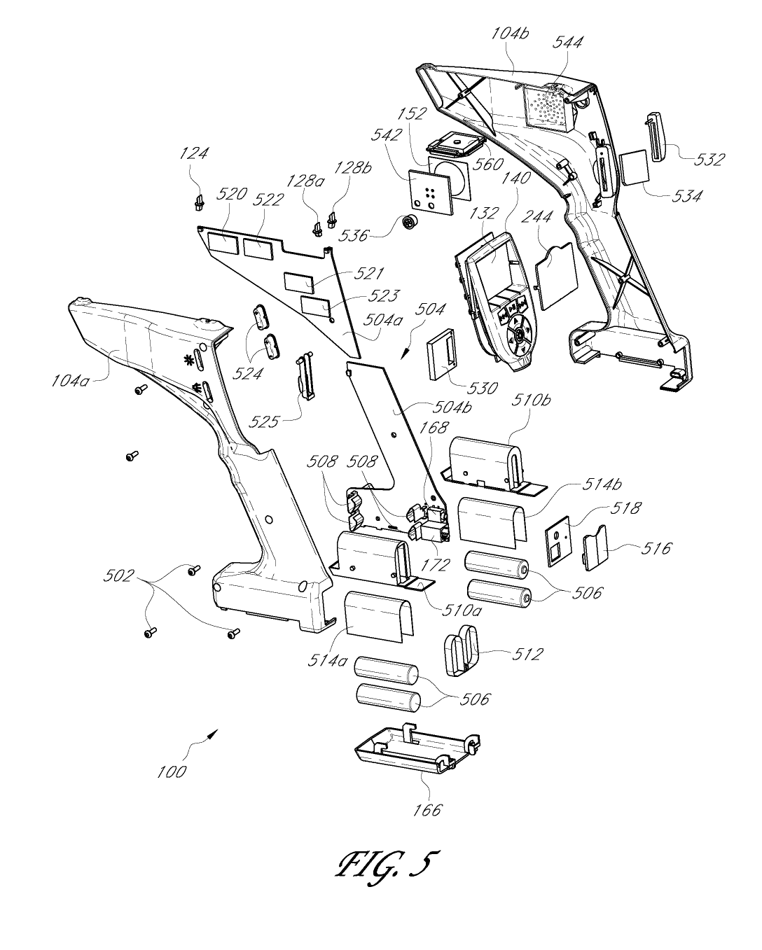

FIGS. 4A and 4B are top and bottom views, respectively, of the device 100. The top view in FIG. 4A shows that the sight 120 is configured with the forward sight 124 disposed at the forward end 113 of the barrel 112 and rearward sight 128 (comprising the aiming indicators 128a, 128b) disposed at the rear end 115 of the barrel 112. The forward 124 and rearward 128 sights are disposed along the aiming axis 212. The aiming indicators 128a and 128b are each slightly offset, transverse to the aiming axis 212, to allow the user to view the forward sight 124 between the indicators 128a, 128b when the device 100 is aimed at a target object. The bottom view in FIG. 4B shows the cover 166, which can be removed to permit access to the power source.

FIG. 5 is an exploded view schematically illustrating some of the components in an embodiment of the device 100. The housing 104 comprises a left housing 104a and a right housing 104b, which are attached via fasteners 502 (e.g., plastite threaded screws). Additionally or alternatively, the housings 104a, 104b may be attached via adhesives, welds, clips, or other suitable fasteners. A printed circuit board (PCB) 504 may be disposed within the housing 104 to mechanically support and electrically couple electronic components and circuitry. The PCB 504 may be fabricated as one or more separate boards and may be configured to have a pistol-like shape generally similar to the pistol-like shape of the device 100. In the embodiment shown in FIG. 5, the PCB 504 comprises two, electrically connected boards: a main PCB assembly 504a and a power PCB assembly 504b. The main PCB assembly 504a is used to electrically interconnect and mechanically support sensing and processing components of the device 100. For example, one or more magnetic sensors 520, one or more gravitational sensors 522, one or more processors 521, one or more storage devices 523 (e.g., volatile and/or nonvolatile memory), and/or other electronic components (e.g., analog-to-digital converters, signal conditioners, boot devices, etc.) may be coupled to the main PCB assembly 504a. The power PCB assembly 504b is used to mechanically support the power source and provide electrical interconnection to the main PCB assembly 504a and other electronic components (e.g., “off-board” components such as the display 132).

In this embodiment, the power source comprises four “AA” batteries 506, which may be disposable or rechargeable. In other embodiments, different numbers of batteries and/or different battery capacities (e.g., “AAA,” 9-volt, etc.) may be used. An optional battery recharger is included in some embodiments. The batteries 506 are accessible through the cover 166, which may be slidably or pivotably connected to the housing 104. The batteries 506 are attached to the power PCB assembly 504b via battery clips 508. In this embodiment, the four batteries 506 are stored as pairs within left and right battery housings 510a and 510b and secured via battery strap 512.

As further discussed below, the device 100 comprises one or more magnetic sensors 520, which are used in part to determine the orientation of the device 100 relative to the Earth's magnetic field. As is well known, metallic materials (especially those containing iron or ferromagnetic substances) can have magnetic fields that potentially interfere with and/or distort the Earth's magnetic field, thereby degrading the ability of the magnetic sensors 520 to measure the undistorted geomagnetic field. The batteries 506, for example, may have jackets (or other portions) that include such ferromagnetic materials and that may contribute to interference with the Earth's field. Accordingly, it may be advantageous to magnetically shield the batteries 506 from the magnetic sensors 520. Generally, magnetic shielding can be provided by physically separating the batteries 506 from the magnetic sensors 520 in order to attenuate interference caused by the batteries and/or by disposing magnetic shielding materials between the batteries 506 and the magnetic sensors 520 that shield or screen unwanted magnetic fields.

In the embodiment shown in FIG. 5, physical separation is achieved by disposing the batteries 506 and the magnetic sensors 520 as far apart as practically possible. For example, the magnetic sensors 520 may be disposed at the forward end 113 of the barrel 112, while the batteries 506 may be disposed toward the bottom of the base 116.

Additionally, in some embodiments, magnetic shields 512a and 512b are disposed substantially surrounding the batteries 506 to shield or screen static and/or low-frequency magnetic fields. As illustrated in FIG. 5, the magnetic shields 512a, 512b can be generally U-shaped to surround battery pairs, while permitting access to the batteries through the cover 166. In some embodiments, the magnetic shields 512a, 512b are disposed within the battery housings 510a, 510b. In other embodiments, one or more magnetic shields substantially surround the battery housings 510a, 510b. In one embodiment, magnetic shields are attached to inner surfaces of the grip portion of the housings 104a, 104b. Many configurations are possible that provide sufficient magnetic shielding to allow the one or more magnetic sensors 520, one or more gravitational sensors 522, one or more processors 521, one or more storage devices 523 and/or other electronic components to operate as intended. In order to shield stray magnetic fields, the magnetic shields 512a, 512b may comprise one or more materials having relatively high magnetic permeability including, for example, nickel-iron alloys such as mu-metal. In some embodiments, MuMetal®, available from Magnetic Shield Corporation, Bensenville, Ill., is used. Although disclosed in the context of a sighting device 100, an artisan will recognize from the disclosure herein that a wide variety of magnetic shielding techniques and materials could be used to assist in magnetic shielding of one or more of the sensor or electronic components in the device 100 or in any other apparatus or device.

The device 100 can have I/O ports such as, for example, the RS-232 port 172 and the headphone jack 168. As shown in FIG. 5, these ports may be connected to the power PCB assembly 504b. To protect the ports while not in use, a port cover 516 may be removably attached to a port connector 518. In other embodiments, these ports (or others) may be connected to the main PCB assembly 504a or to other suitable locations in the housing 104. The memory card port 164 (see FIG. 1B) can be used to insert a memory card 534 into a memory card reader 530. An optional memory port cover 532 may be used to protect the memory card 534.

The device 100 has various switches and controls, including the on/off switch 536. Audiovisual controls (e.g., display brightness 144 and audio volume 148) can be provided by toggle buttons 524. In other embodiments, thumbwheels, dials, or other controls can be used. As shown in FIG. 5, the trigger 160 may comprise a pivotable element 525. In other embodiments, a push button is used.

Audio output is provided by the speaker 542 which is disposed in the right housing 104b and held in place by backing plate 542. Holes or perforations 544 may be formed into the right housing 104b to permit sound to more freely leave the unit, thereby improving audio quality.

Visual output for the device 100 is provided by the display 132. The housing 140 for the display 132 and the keys 136 is attached between the left and right housings 104a, 104b at the rear end 115 of the barrel 112 of the device 100. As described above, the housing 140 may be relatively sturdy and shock resistant elastomeric material that protects the display 132 and the keys 136 from damage. The display 132 may be configured to minimize interference with the user's night adaptation by attaching the red filter 244 to the housing 140.

Some embodiments of the device 100 comprise additional electronic components. For example, it may be advantageous for the device 100 to receive signals from a satellite navigation system such as, e.g., the Global Positioning System (GPS), the Galileo positioning system (being developed by the European Union), and/or the Global Navigation Satellite System (GLONASS, developed by Russia and India). Satellite signals can provide accurate navigation information including the current time and date and the device's geographic position on the Earth (e.g., longitude and latitude and elevation). Accordingly, the device 100 may include a navigation module 560 configured to receive RF satellite signals and determine navigation information. In some embodiments, the navigation module 560 comprises a multichannel GPS receiver module such as, e.g., a GXB5205 Antenna Embedded GPS Receiver Module, available from Sony Electronics, Inc. The navigation module 560 may support differential and/or augmented satellite navigation protocols to provide location information with higher accuracy. In order to provide improved reception of the navigation signals from visible satellites, the navigation module 560 advantageously may be disposed near the top of the device 100, e.g., substantially as shown in FIG. 5.

In order to provide easier use at night, the device 100 and/or the sight 120 may comprise illuminated portions. For example, portions of the sight 120 may be illuminated to enable the user to more readily determine when the device 100 is aligned with a target object. For example, the sight 120 may comprise an illuminated reticle or cross-hair. In other embodiments, the forward 124 and rearward 128 sights may be illuminated or may comprise lighted portions. For example, the sight 120 may include LEDs and/or fiber optics, as well as imaging elements such as lenses and/or mirrors, to provide one or more illuminated aiming indicia. In the embodiment shown in FIG. 5, the forward sight 124 and the aiming indicators 128a, 128b are in the form of “light pipes.” A light pipe may comprise substantially transparent or translucent material having an upper angled surface. Light from a light source (e.g., an LED disposed within the housing 104) that is transmitted into the light pipe will be reflected off the angled surface and thereby diverted into a different direction. As shown in FIG. 5, the angled surface of the light pipe is oriented so that light is diverted along the aiming axis 212 toward a user's eye. The angled surface may be formed at an angle of about 45 degrees to the initial light propagation direction in order to divert the light by about 90 degrees. In other embodiments, the light pipe may be configured to include other shapes including, some or all of a sphere, a prism, or other suitable shape. Additional optical elements, including one or more lenses or mirrors, may be used with the light pipe. The light pipe may be fabricated from glass, plastic, or other suitable material that substantially transmits at least a portion of the visible light spectrum. To reduce degradation of the user's night vision, red light (e.g., from a red-emitting LED) preferably is propagated by the light pipe. Other colors may be used. In some embodiments, the forward 124 and rearward 128 sights transmit different colors.

Other embodiments of the device 100 may have additional or fewer features and components than depicted in FIGS. 1A-5. For example, certain embodiments of the device 100 comprise a lighting unit 640 capable of generating a beam of light that can be directed toward the object. The user and/or nearby observers can view the light beam, for example, to see which object toward which the device 100 is pointed or directed. The lighting unit 640 may comprise a laser capable of emitting light in the visible portion of the electromagnetic spectrum. In some embodiments, the emitted light is predominantly in a wavelength range from about 500 nm to about 550 nm (e.g., “green” light). In other embodiments, the emitted light is primarily in other wavelength ranges such as, for example, about 450 nm to about 500 nm (e.g., “blue” light) or about 600 nm to about 700 nm (e.g., “red” light). The lighting unit 640 may be disposed within the housing 104 or attached to the outside of the device 100 (e.g., along a top or a side of the device 100). In some embodiments, the lighting unit 640 is disposed adjacent (or otherwise attached) to the sight 120. In one embodiment, the sight 120 comprises the lighting unit 640, which may be capable of emitting the light beam parallel to the barrel 112 of the device 100.

The lighting unit 640 may be configured to direct the light beam along or substantially parallel to the aiming axis 212 (and/or the longitudinal barrel axis 208) of the device 100. The light beam advantageously may assist the user in aiming the device 100 toward an object. An additional benefit is that nearby observers can see the light beam (e.g., via reflection of the beam off particulates in air) and determine where the user has pointed the device 100. In other embodiments, the light beam may be directed along a different direction than the aiming axis 212 by the use of optical elements such as, e.g., lenses, mirrors, gratings, beamsplitters, spatial light modulators, etc. and/or mechanical elements such as, e.g., motors, actuators, etc. In such embodiments, the light beam may be directed toward a desired or target object, thereby assisting the user in orienting the device 100 toward the desired or target object. In some implementations, the light beam can be directed so as to appear to encircle or otherwise identify the desired or target object or to indicate a relationship among a group of objects. An artisan will recognize from the disclosure herein that the light beam can be used for a wide range of purposes, including assisting observers identify or locate remote objects and many others. For example, in some embodiments, the lighting unit 640 comprises a laser range finder capable of determining distance to a remote object (e.g., a remote terrestrial object).

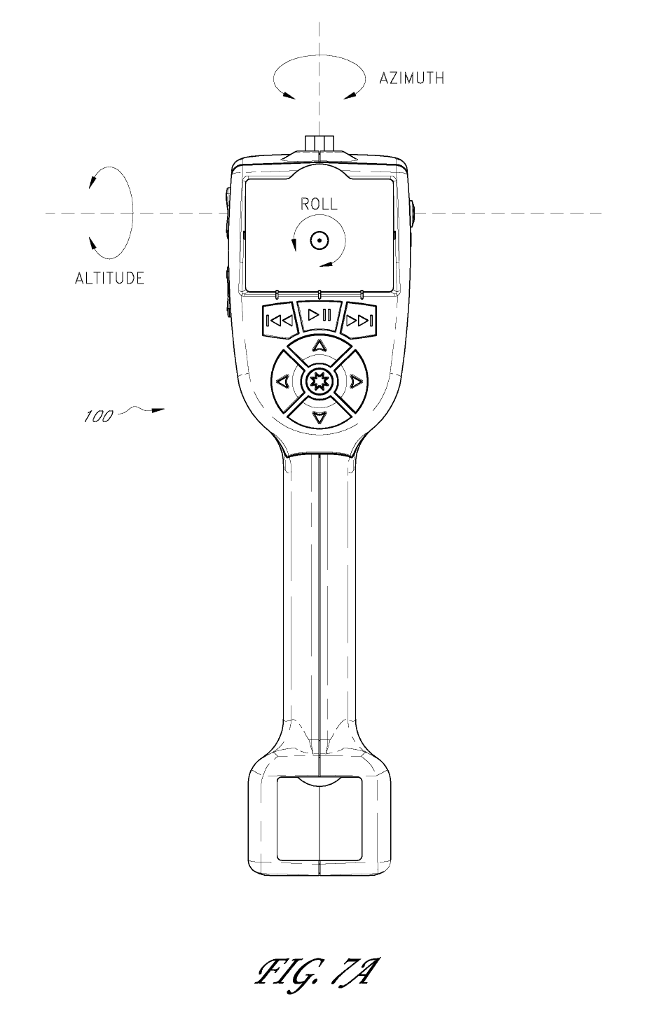

FIG. 6 is a block diagram schematically illustrating a control system 600 for an embodiment of the sighting device 100. Some or all of the control system 600 may be populated on one or more circuit boards such as, for example, the main PCB assembly 504a and/or the power PCB assembly 504b (see FIG. 5). The control system 600 comprises a processor 602, which, in some embodiments, implements the firmware architecture of the device 100. The processor 602 may perform high-level application execution tasks, data handling, and numerical processing. The processor 602 may comprise a general purpose processor (or computer), a field-programmable gate array (FPGA), an application specific integrated circuit (ASIC), a programmable logic device (PLD), or other suitable microcontroller, microprocessor, or electronic logic modules. The processor 602 may include internal storage (memory), clocks, I/O buses, peripheral interfaces, etc. The processor 602 may include analog-to-digital (A/D) and/or digital signal processing (DSP) capabilities. In some embodiments, the processor 602 comprises a Blackfin® ADSP-BF531SBBCZ400 processor available from Analog Devices, Inc. (Norwood, Mass.). Although FIG. 6 depicts one processor, two or more processors are used in certain embodiments.

As will be further described below, the orientation of the device 100 can be determined by one or more gravity sensors 604 and/or one or more magnetic sensors 606. The gravity sensor 604 may comprise a one-axis, two-axis, and/or three-axis sensor responsive to acceleration in one, two, or three dimensions, respectively. In some embodiments, the gravity sensor 604 comprises three one-axis sensors oriented substantially orthogonally to each other. In various embodiments, a two-axis sensor may comprise a unitary sensor or two one-axis sensors oriented substantially orthogonally. The gravity sensor 604 advantageously may be used to measure static acceleration (e.g., the Earth's gravity) as well as dynamic acceleration. In some embodiments, the gravity sensor 604 is oriented in the device 100 so that the sensor 604 can provide high sensitivity to measurements of the Earth's gravitational acceleration. For example, some gravity sensors have a most sensitive axis which may be oriented approximately perpendicular to the Earth's gravitational acceleration to provide highest sensitivity. Other gravity sensors 604 may be oriented in the device 100 to provide sensitivity over a wide range of device orientations. In certain embodiments, two-axis accelerometers are used to measure the tilt of each principal axis of the device 100 (e.g., altitude and roll, as further described below). The gravity sensor 604 may comprise one or more accelerometers and/or inclinometers. The gravity sensor 604 may utilize a microelectromechanical systems (MEMS) device, a capacitive device, a thermal device, a gyroscope, an optical inertial measurement device, or any other suitable device capable of measuring acceleration. In some embodiments, the gravity sensor 604 comprises one or more ADXL322JCP dual-axis accelerometers available from Analog Devices, Inc. (Norwood, Mass.).

A magnetic sensor 606 may comprise a one-axis, two-axis, and/or three-axis sensor capable of measuring one, two, or three dimensional magnetic fields, respectively. The magnetic sensor 606 may comprise one or more magnetometers that utilize, for example, magnetoresistive effects to measure magnetic fields. In other embodiments, fluxgate magnetometers, MEMS magnetic sensors, or other suitable magnetic field sensor can be used. The magnetic sensor 606 advantageously may be used to measure static magnetic fields (e.g., the Earth's magnetic field) as well as dynamic magnetic fields. In some embodiments, a three-axis magnetic sensor comprises a two-axis magnetic sensor and a one-axis (e.g., z-axis) magnetic sensor to measure the magnetic field component out of the plane of the two-axis sensor. Alternatively, the magnetic sensor 606 may comprise three one-axis magnetic sensors oriented substantially orthogonally to each other. In certain embodiments, the magnetic sensor 606 comprises a three-axis magnetic sensor comprising an HMC1022 and an HMC1021Z magnetic sensor available from Honeywell Corporation (Plymouth, Minn.).

The device 100 may optionally include a temperature sensor, which can be used to provide temperature readings to correct for temperature dependent effects in the sensors 604, 606 (or other components).

The sensors 604, 606 may output an analog or digital signal, which may optionally be processed by one or more signal conditioning modules 612 and/or digital signal processors (DSP) 624. The signal conditioning modules 612 and the DSP may be integrated with the processor 602 or may be separate electronic components. The optional signal conditioning module 612 (and/or optional DSP 624) may, for example, sample and digitize an analog signal from one or more of the sensors 604, 606 and then multiplex, amplify, filter, transform, clip, interpolate, extrapolate, or otherwise condition the digitized signal. Analog signal conditioning is possible. For example, the sensor signal may be low-pass filtered to remove noise and other high-frequency signals or to provide a suitable signal for Nyquist sampling. A skilled artisan will recognize that many signal processing techniques are well known in the sensing arts.

The control system 600 operates on electricity provided by a power source 608, comprising, for example, batteries and/or fuel cells. As described above, certain embodiments of the device 100 magnetically shield the power source 608 (and/or other components) to reduce magnetic interference with the magnetic sensors 606.

The control system 600 may also include storage 614, which may comprise volatile memory 614a and/or nonvolatile memory 614b. In some embodiments, the storage 614 is integrated with the processor 602. The storage 614 may comprise one or a combination of random access memory (RAM), read only memory (ROM), flash memory, hard disks, or other suitable data storage device or component. The control system 600 optionally may also include removable storage 616, which may comprise, for example, a flash memory card that can be inserted into (and removed from) memory card port 164 (see FIG. 1B). The storage 614 (and optionally 616) may be used to store data, instructions, executable commands, user preferences, and any other suitable information. In certain embodiments, a database of celestial (or terrestrial) objects is stored in the memory 614 and/or 616. In the case of celestial objects, the database typically includes information related to the position of the objects on the celestial sphere (e.g., coordinates such as right ascension and declination). In the case of terrestrial objects, the database typically includes information related to the position of the objects relative to the Earth (e.g., coordinates such as longitude, latitude, and elevation). The database may include (or have links to) interesting historical, anecdotal, and/or entertaining information related to the celestial (or terrestrial) objects. Other data (and/or databases) may be stored in storage 614 and/or 616. For example, data related to the Earth's magnetic field can be stored. Audio and/or visual information may be stored in the device storage 614 and/or 616. For example, audio data can include sounds, speech, and/or music files, and visual data can include text, graphics, images, and videos.

Embodiments utilizing removable storage 616 may provide many advantages. For example, the removable storage (e.g., a flash memory card) can be used to upgrade and/or update of the firmware of the processor, to store new or different object databases than are stored internally (e.g., in the storage 614), and to provide new “sky tours” that direct the user to interesting objects in the night sky. The removable storage 616 can be used to store a history of the objects located and/or identified by the user (e.g., a personal “sky tour”). A user can transfer the removable storage 616 to another sighting device or a telescope for “replay” of the personal sky tour. The user can also transfer the data on the removable storage 616 to another memory device for archival and/or analysis purposes.

A boot device 610 may be included in the control system 600. The boot device 610 may be used to load the operating system, other software, applications, and/or utilities, initialization data, and/or user settings when the device 100 is turned on via the switch 156. The boot device 610 may comprise an electrically erasable programmable read only memory (EEPROM) or other suitable form of nonvolatile memory. In some embodiments, certain data, applications, and/or initializations may additionally or optionally be stored in the nonvolatile memory 614b or be accessible from a flash memory card inserted in the nonvolatile memory port 164.

The control system 600 includes an I/O interface 618 and an audiovisual interface 620. These interfaces may include suitable drivers for peripheral components. For example, the I/O interface 618 may comprise a universal asynchronous receiver/transmitter (UART) device capable of handling asynchronous serial communication. A UART device may communicate with the RS-232 port 172. The I/O interface 618 may include USB and/or IEEE 1394 (Firewire®) connectivity. The I/O interface 618 also may be used to receive user input via the keys 136, the trigger 160, the brightness 144 and volume 148 controls, the on/off switch 156, as well as any other suitable input device. The audiovisual interface 620 may be used to control output to the display 132, speaker 152, and/or headphone jack 168 or to provide suitably formatted signals for peripheral display devices (e.g., a remote display screen, a cell phone, PDA, iPod, etc.).

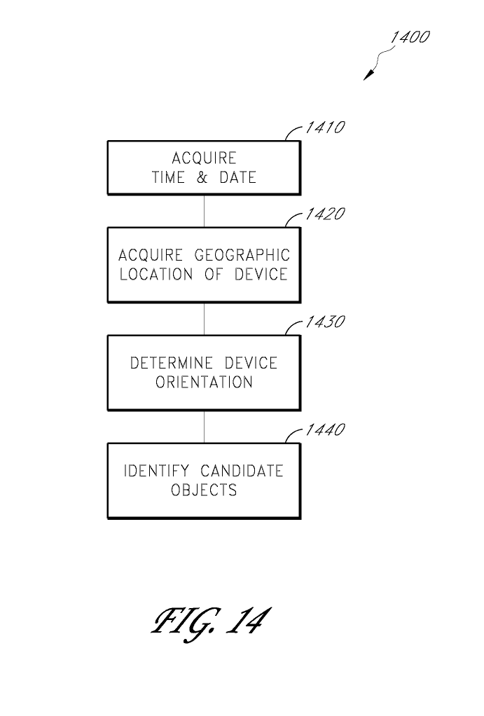

The audiovisual interface 620 also may be used to provide directional indicators that direct the user to point the device 100 toward a desired location. For example, the display 132 may show directional indicators such as one or more arrows (or alphanumeric characters, graphics, and/or icons) showing the user the direction in which to move the device 100 (e.g., see FIG. 13 for an example of one directional display interface). In other embodiments, the directional indicators may include lights (e.g., LEDs), sounds (e.g., beeps or chimes, synthesized and/or recorded voice or speech), tactile indicators (e.g., vibrators), etc. The audiovisual interface 620 may be configured to refresh the display 132 (or other visual indicators) at a sufficiently high rate to track the user's movement of the device 100.

The control system 600 may include additional electronic components in some embodiments. For example, a satellite navigation module 622 may optionally be included to provide reception of GPS signals. The GPS signals advantageously provide the device 100 with accurate and precise information related to the current time and date and to the position of the device 100 with respect to the Earth (e.g., longitude, latitude, and elevation). The control system 600 is capable of using the GPS information in determining the celestial position toward which the device 100 is aimed. Some embodiments of the control system 600 include a clock, which may be used to obtain time and date information (although this information typically has less precision than GPS information). Other embodiments may include an RF receiver configured to receive timing information available from National Institute of Standards and Technology (NIST) radio broadcasts (e.g., stations WWV, WWVH, and/or WWVB).

Although FIG. 6 schematically illustrates an example of the control system 600 in one embodiment of the device 100, this example is intended to be illustrative and not limiting. Some or all of the electronic components, modules, and interfaces may be combined (or omitted) in other embodiments. Further, some or all of the electronic components, modules, and interfaces may be disposed in devices remotely located from the sighting device 100. For example, in one embodiment, the device 100 is a relatively “dumb” unit that piggybacks off the processing capabilities of other components (e.g., a computer or a telescope control system). In this embodiment, the device 100 comprises the gravity and magnetic sensors 604 and 606, which are configured to output device orientation information to the remote processing unit. The remote processing unit performs any associated calculation tasks such as, e.g., identifying the object. The remote processing unit may output relevant object-related information on its own display (if present). Many variations of the sighting device 100 are possible.

Additional features, functionality, and enhancements may be included in certain embodiments of the device 100. A skilled artisan will recognize that the control system 600 for the device 100 may be implemented in many different ways and by using many different types of electronic components.

### Device Orientation

The orientation of the device 100, e.g., the direction in which the device 100 is aimed or pointed may be measured in terms of a three-dimensional coordinate system. For example, two well-known angular coordinate systems are pitch, roll, and yaw angles and Euler angles. Other well-known techniques for determining device orientation include direction cosines, rotation matrices, and quaternions. A skilled artisan will recognize that the control system 600 can be configured to utilize information provided by the gravity sensor 604 and/or the magnetic sensor 606 to determine device orientation according to any suitable coordinate system or technique.

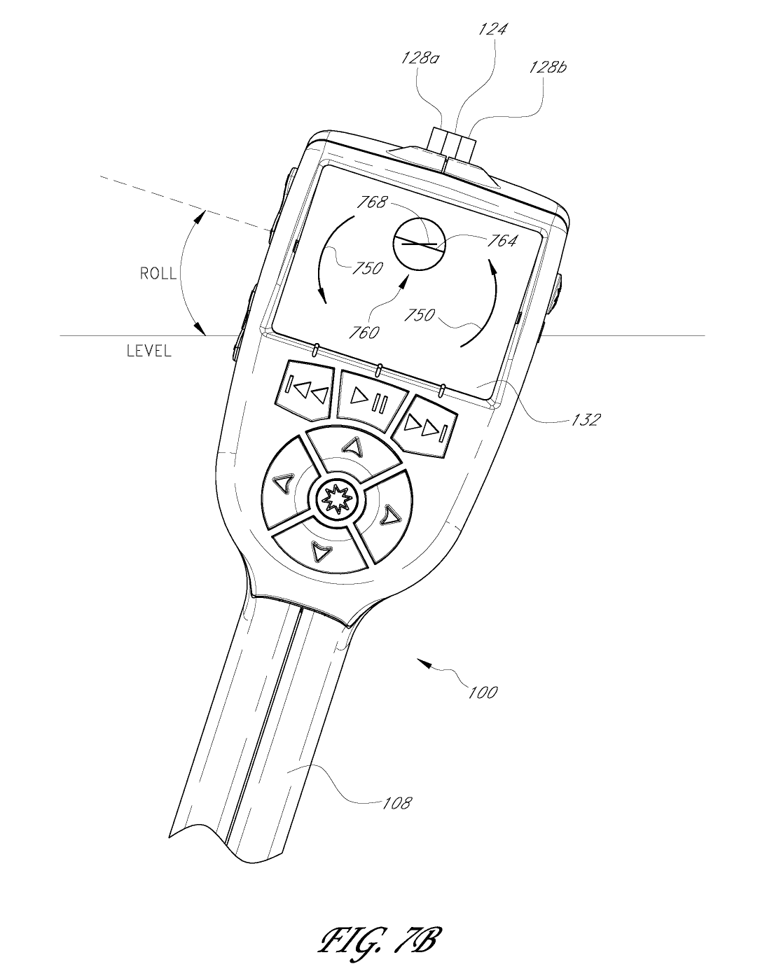

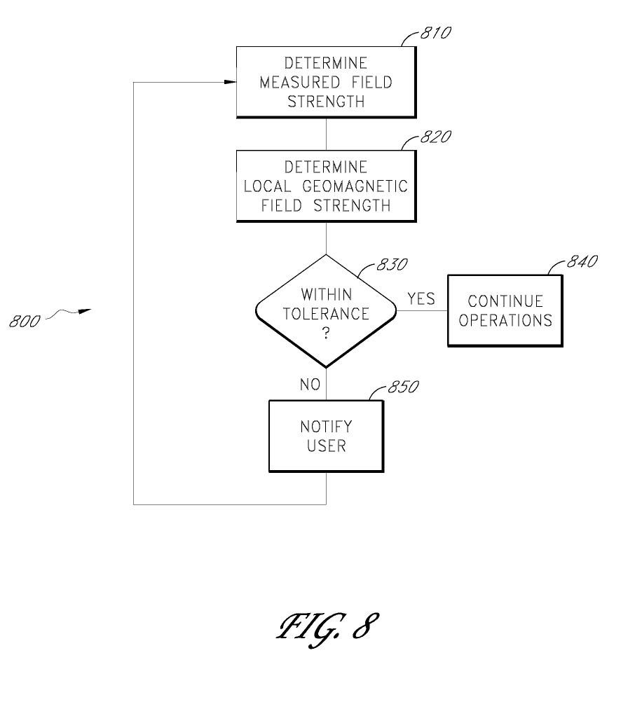

In some embodiments, a pitch, roll, and yaw system is used to measure device orientation. In this system, pitch is conventionally referred to as “altitude,” and yaw is conventionally referred to as “azimuth.” FIG. 7A schematically illustrates device orientation in terms of altitude, azimuth, and roll in this system. Altitude is a measure of the inclination (or tilt) of the device 100 relative to a fixed plane, which may be taken to be the horizon of the Earth at the location of the device 100. With this choice of fixed plane, when the device 100 points toward the horizon, the altitude is 0 degrees, and when the device 100 points directly overhead (the zenith), the altitude is 90 degrees. Azimuth is a measure of the angular position of the device 100 relative to a fixed direction in the fixed plane. In some embodiments, the fixed direction is true (geographic) North. With this choice, the azimuth of North is 0 degrees, East is 90 degrees, South is 180 degrees, and West is 270 degrees. Roll is a measure of the angular rotation about a longitudinal axis passing through the device 100. In some embodiments, the longitudinal axis is selected to be the longitudinal axis 208 of the barrel or the aiming axis 212. Roll may be measured clockwise from a position where the device 100 is oriented in an upright manner. For example, roll is 0 degrees for the device orientation shown in FIG. 7A. If the device 100 were turned “upside down,” roll would be 180 degrees.

The control system 600 may be configured to use measurements from the gravity sensor 604 and/or the magnetic sensor 606 to determine the orientation of the device 100, e.g., altitude, azimuth, and roll. A skilled artisan will recognize that many techniques can be implemented to determine device orientation from the sensor measurements. For example, some embodiments of the control system 600 may utilize techniques described in U.S. Pat. No. 5,311,203, issued May 10, 1994, entitled “Viewing and Display Apparatus,” which is hereby incorporated by reference herein in its entirety. Although certain example techniques are further discussed below, these techniques are intended to be illustrative and not to be limiting.

In general terms, the gravity sensor 604 may be used to determine the altitude and/or the roll of the device 100. For example, in some embodiments, the gravity sensor 604 is configured to measure the Earth's gravitational field, which is directed toward the center of the Earth and is perpendicular to the horizon plane. It is well known that as the altitude and roll of the device 100 change, components of the Earth's gravitational acceleration measured by the gravity sensor 604 will correspondingly change. The control system 600 can be configured to receive and process measurements of one or more components of the Earth's gravitational acceleration so as to provide altitude and/or roll information. In some embodiments, the gravity sensor 604 is capable of measuring three substantially orthogonal components of the Earth's gravitational acceleration. An advantage of such embodiments is that both altitude and roll may be relatively accurately determined over a wide range of device orientations. In other embodiments, a two-axis accelerometer is used to measure altitude, and a separate two-axis accelerometer is used to measure roll. The sensing planes of the altitude and roll accelerometers preferably are oriented substantially at right angles. An advantage of using a two-axis accelerometer to measure an angular orientation (e.g., altitude or roll) is that the two-axis sensor is relatively accurate over a wide range of angles. In other embodiments, the control system 600 comprises a gravity sensor 604 that is configured to determine only altitude of the device 100.

The magnetic sensor 606 may be used to measure the azimuth of the device 100. In general terms, the magnetic sensor 606 acts as a compass and can be used to determine the angular bearing of the device relative to magnetic north. The azimuth of the device 100 measured from true (geographic) North can be determined from the angular bearing and knowledge of the local angle between true North and magnetic north (known as magnetic declination). As further discussed below, in some embodiments the magnetic sensor 606 is also used to determine the roll of the device 100.

The Earth's magnetic field defines a reference direction relative to which device orientation can be measured. In various embodiments, the magnetic sensor 606 detects one or more components of the Earth's magnetic field. The control system 600 may use the magnetic component measurements to calculate device orientation relative to the Earth's magnetic field direction via any of the many well-known techniques.

For example, in some embodiments a three-axis magnetometer is used to measure all three components of the Earth's field (or equivalently, field strength and field direction). In other embodiments, a two-axis magnetometer is used to measure the magnetic field components in a reference plane of the device 100 and a one-axis sensor (often called a “z-axis” sensor) is used to measure the field component perpendicular to the reference plane. The reference plane conveniently may be chosen to include the longitudinal axis 208 of the barrel 108 and to be oriented at 0 degrees of roll. In another embodiment, a one- or two-axis magnetometer is used to determine one or both magnetic field components in the reference plane, and a z-axis magnetic sensor is not used.

Because the geomagnetic field points to magnetic north (and not to geographic North), information about the local geomagnetic field can be used to convert or transform device orientation relative to the Earth's magnetic field into device orientation relative to true North. For example, as is familiar from map-and-compass navigation, a known or estimated value of the magnetic declination at the user's location may be used to convert magnetic bearing (relative to magnetic north) into azimuth (relative to true North). In certain embodiments, the three-dimensional orientation of the device 100 with respect to the Earth's three-dimensional magnetic field vector is used to provide more accurate pointing of the device 100 relative to the celestial sphere.

The Earth's magnetic field depends on the user's position on the Earth. In some embodiments, the device 100 uses a database to store geomagnetic field information. The database may be stored in the data storage 614 and/or 616. In some embodiments, the geomagnetic field information is accessible via a data network (e.g., the Internet). The database may include information about the geomagnetic field components (or, equivalently, field direction and magnitude) or in another suitable format (e.g., field strength, declination, and inclination). In certain embodiments, the database includes geomagnetic information for a large number of cities, towns, and/or postal codes (e.g., zip codes) within a geographic region. The geographic region preferably includes the position of the user of the device 100. The geographic region may be the entire world or a portion thereof (e.g., the northern hemisphere, the U.S., California). In certain such embodiments, the geomagnetic field at the user's position is estimated by, for example, using the data for the nearest city or town, or by interpolating within the database (or extrapolating, if necessary). For example, in one embodiment, the user enters his position (e.g., via the keys 136), and the control system 600 estimates the Earth's magnetic field by interpolating the geomagnetic information for the four nearest cities or towns in the database. In other embodiments, a greater or lesser number of cities or towns may be used. In another embodiment, the geomagnetic information is specified by a postal code (e.g., zip code). In other embodiments, geomagnetic information may be stored in the database in terms of longitude and latitude or in terms of any other reference system. Although a database may be used, geomagnetic information can be stored in any suitable form or format, for example, as a table or as parameterized data.

In other embodiments, the device 100 stores a mathematical model of the Earth's magnetic field from which local values of the geomagnetic field components can be calculated. The geomagnetic model can be stored in the data storage 614 and/or 616. Suitable geomagnetic models include the International Geomagnetic Reference Field (IGRF) released by the International Association of Geomagnetism and Aeronomy (IAGA) (available at http://www.ngdc.noaa.gov/IAGA/vmod/igrf.html) and the World Magnetic Model (WMM) produced by the United States National Geospatial-Intelligence Agency (NGA) (available at http://www.ngdc.noaa.gov/seg/WMM/DoDWMM.shtml).

The Earth's magnetic field varies slowly with time. Accordingly, some embodiments of the device 100 provide for updating the geomagnetic information, for example, by making revised geomagnetic data or models available over a data network (e.g., the Internet) or on flash memory cards that are available to the user. In some implementations, time-dependent mathematical models of the geomagnetic field are used to provide more accurate estimates than static mathematical models.

In certain embodiments, the magnetic sensor 606 comprises a three-axis magnetometer capable of measuring values of the three components of the Earth's magnetic field vector at the user's position. The three field components can be used to determine the measured strength of the Earth's magnetic field (e.g., the magnitude of the magnetic field vector). The control system 600 can compare the measured values of the field components with reference values for the Earth's magnetic field (e.g., from a geomagnetic database and/or geomagnetic model) to determine the orientation of the device 100. An advantage of measuring all three components of the local magnetic field is that the control system 600 can determine the orientation of the device 100 in three dimensions, e.g., altitude, azimuth, and roll.

In other embodiments, a two-axis magnetometer is used to measure magnetic field components in the reference plane of the device 100. The control system 600 can combine these measurements to determine azimuth. Azimuth determined in these embodiments is subject to inaccuracy, because any pitch or roll of the device 100 will introduce errors into the measured magnetic field components. Accordingly, in some of these embodiments, a z-axis magnetic field sensor is used to determine the magnetic component perpendicular to the reference plane. The control system 600 can use the z-axis information to reduce the aforementioned errors by determining, and correcting for, device altitude and roll. In some embodiments, the control system 600 additionally (or optionally) determines device altitude and roll from the gravity sensor 604 and uses these values to provide more accurate azimuth determination.

The device 100 may be configured to output one or more “roll indicators” that show the user how to hold the device level (e.g., with zero roll). FIG. 7B schematically illustrates a rear view of the device (e.g., from the user's perspective). The user has “tilted” the device 100 so that it is oriented with a non-zero roll angle. In this embodiment, the display 132 shows roll indicator arrows 750 that graphically indicate the direction in which the user's hand should be rotated to return the device 100 to a level position. The display also shows a roll indicator 760 that may be generally similar to an attitude indicator in an aircraft. The roll indicator 760 comprises an “artificial horizon” 764 and a graphic 768 that is indicative of the current roll of the device 100. In other embodiments, different graphics may be used. Also, in other embodiments, a roll indicator may comprise one or more lights (e.g., LEDs) that illuminate when the device 100 is “rolled” sufficiently. Warning sounds, beeps, alarms, and/or synthesized speech may also be used. It is contemplated that many types of roll indicators can be used.

It is well know that ferrous and ferromagnetic materials can distort, amplify, and otherwise interfere with the Earth's magnetic field. Additionally, electromagnetic devices such as power lines, motors, and generators, can produce substantial magnetic fields that can interfere with the Earth's field. The presence of such materials and devices in the vicinity of the sighting device 100 can cause the field components measured by the magnetic sensor 606 to differ from the true values for the Earth's magnetic field. Such differences will lead to errors in the calculated device orientation.

To reduce magnetic interference by ferromagnetic materials (and/or electromagnetic devices) disposed in or on the device 100, some embodiments magnetically shield such materials (and/or devices) to reduce their magnetic interference with the magnetic sensor 606. As described above with reference to FIG. 5, a magnetic shield of relatively high permeability material (e.g., mu-metal) may be disposed substantially around ferrous or ferromagnetic materials or electromagnetic devices (e.g., the batteries 506). Additionally or alternatively, magnetic materials (and/or devices) may be spaced apart from the magnetic sensor 606 in order to attenuate stray magnetic fields.

A skilled artisan will recognize from the disclosure herein that various techniques can be used to reduce magnetic interference from ferrous and ferromagnetic materials and/or electromagnetic devices disposed outside the device 100. For example, the user can be instructed to use the device 100 in locations that are at a distance from potential sources of stray fields (e.g., nearby automobiles, steel-framed buildings, high-tension power lines, buried electromagnetic cables, electric motors or generators).

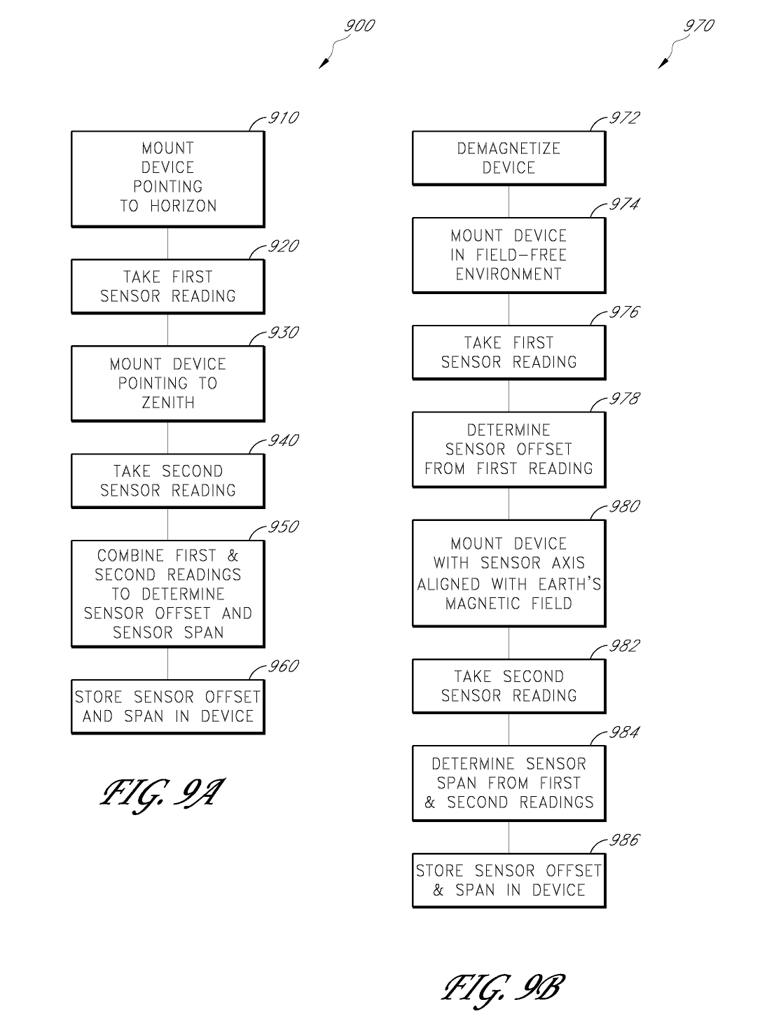

In some embodiments, the device 100 is configured to notify the user about the possible presence of magnetically distorting material or devices. FIG. 8 is a flowchart that schematically illustrates an example process flow 800 for estimating whether magnetic distortion is present. The process flow 800 can be implemented as executable instructions performed by the processor 602 in the control system 600 (see FIG. 6). In block 810, the control system 600 calculates the strength (e.g., the magnitude) of the magnetic field measured by the magnetic sensor 606. The magnetic sensor 606 preferably is capable of measuring three substantially orthogonal components of the magnetic field. In block 820, the control system 600 determines the strength of the geomagnetic field at the user's position on Earth. In some embodiments, the local geomagnetic field strength is calculated from information stored in a geomagnetic database and/or from a geomagnetic model. Suitable geomagnetic information may be stored in the data storage 614 and/or 616. By comparing the measured and the geomagnetic field strengths, the control system 600 can estimate whether the geomagnetic field has been modified by nearby magnetic structures. For example, in block 830, the control system 600 determines if the measured field strength and the geomagnetic field strengths are approximately equal to within a tolerance. If so, there likely is little or no field distortion, and the process 800 moves to block 840 where the control system 600 continues normal operation. However, if the measured and geomagnetic field strengths have substantially different values (e.g., outside the tolerance), then there likely has been magnetic distortion or interference.

If the control system 600 determines that magnetic distortion likely has occurred, the process 800 moves to block 850 where the control system 600 notifies or otherwise provides an alert to the user via one or more audiovisual outputs (e.g., via the display 132 and/or the speaker 152). For example, the display 132 may output text and/or graphics instructing the user to move to a nearby location and try the measurement again. Alternatively or additionally, the control system 600 may actuate audible or visual indicators (e.g., a light, an LED, an alarm, etc.). The process flow 800 returns to block 810, and the check for nearby magnetic distortion is repeated.

In some embodiments of the device 100, a process flow similar to that illustrated in FIG. 8 is used to estimate whether the gravity sensor 604 has correctly measured the Earth's gravitational acceleration or whether vibrations, oscillations, or other accelerations of the device 100 have introduced errors. In this process flow, the magnitude of the Earth's gravitational acceleration (about 9.8 m/s²) is used instead of the magnitude of the Earth's magnetic field in the analog of block 820.

Additionally, in certain embodiments, the measurements taken by the gravity and/or magnetic sensor 604, 606 are averaged over a time interval in order to determine an averaged sensor measurement, which may be more accurate and precise due to the time-averaging of measurement errors. In other embodiments, the sensor measurements may be filtered by one or more analog and/or digital filters, which also may yield more accurate and precise measurements as is well known in the signal processing arts. In some embodiments, a Kalman filter (or other suitable control systems method) may be applied to the sensor measurements (e.g., magnetic and/or gravity sensor measurements) to determine a more accurate and precise estimate of the orientation of the device 100. In certain embodiments, a combination of the above techniques is used.

### Device Calibration

The device 100 optionally may undergo one or more calibration procedures prior to being distributed to an end user. A calibration procedure advantageously provides a quality control check on the components of the device 100. Additionally, the calibration procedure may determine calibration information for the sensors 604, 606, thereby providing more accurate sensor measurements. For example, it may be advantageous for the sensors to be able to determine device orientation to an accuracy of about ±0.5 degrees in altitude and about ±1.0 degrees in azimuth. To achieve this orientation accuracy, the calibration procedures and instrumentation preferably have an accuracy greater by about a factor of two (e.g., ±0.25 degrees in altitude and ±0.5 degrees in azimuth).

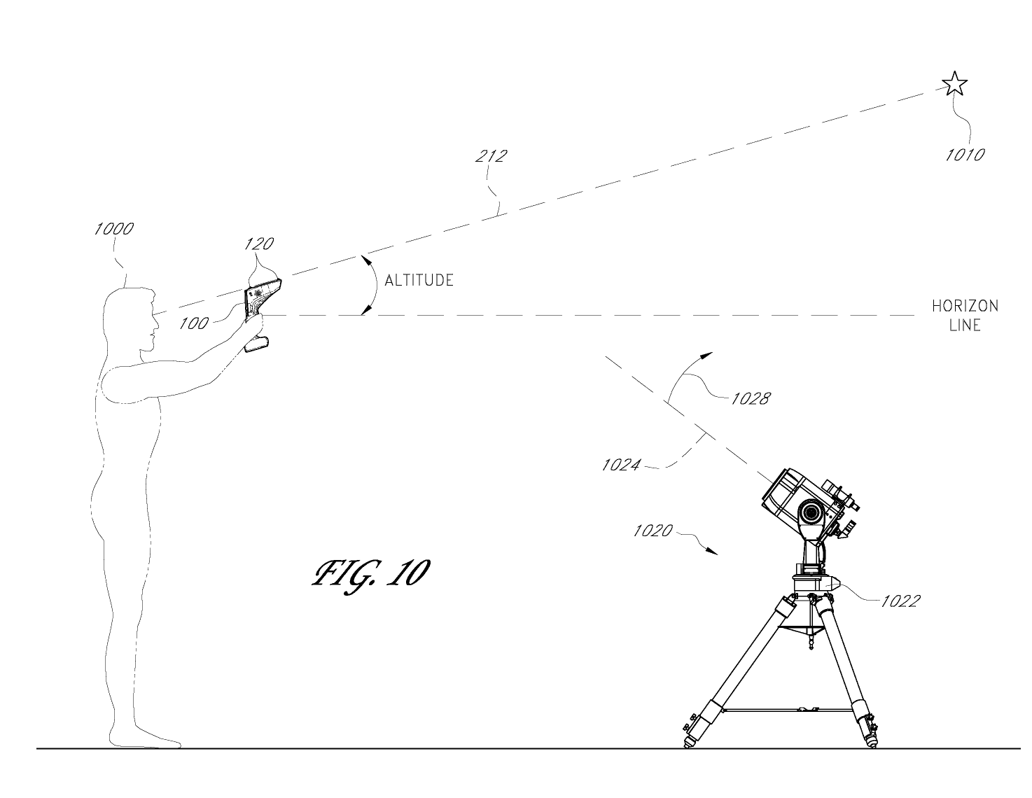

FIG. 9A is a flowchart schematically illustrating an example process flow 900 that may be used to calibrate the gravity sensor 604 of the device 100. In block 910, the device 100 is mounted in a calibration fixture that secures the device 100 in a level position with the longitudinal barrel axis 208 pointing toward the horizon. In block 920, a first reading of the gravity sensor 606 is taken. In block 930, the device 100 is mounted substantially orthogonally in the calibration fixture, e.g., pointing toward the zenith. In block 940, a second reading of the gravity sensor 604 is taken. In block 950, the first and second readings are combined to determine a sensor offset and a sensor span. The sensor offset reflects engineering errors that cause non-zero sensor readings in situations where the sensor ideally should output a null value. The sensor span reflects the output range of the sensor in the gravitational field of the Earth. In block 960, the sensor offset and span are stored in the device 100, for example, in the boot EEPROM device 610 and/or the nonvolatile storage 614b. In ordinary use, measurements of gravitational acceleration components are adjusted using the stored sensor offset and span to provide more accurate and precise measurements. For example, an adjusted sensor reading may be determined as (sensor reading—sensor offset)/span.

FIG. 9B is a flowchart schematically illustrating an example process flow 970 that may be used to calibrate the magnetic sensor 606 of the device 100. In block 972, the device 100 is demagnetized (degaussed) by, for example, passing the device 100 through an alternating current demagnetizing loop. In block 974, the device 100 is mounted in a calibration fixture that secures the device 100 in a substantially magnetic field-free environment. The magnetic field-free environment may be produced by placing the device 100 near the magnetic nulls generated by multiple Helmholtz and/or Maxwell coils. Alternatively, one or more solenoids or coils can be used to generate a magnetic field that, at least in part, cancels the local geomagnetic field. In some implementations, the device 100 is disposed in a magnetic isolation chamber that substantially shields the device 100 from nearby magnetic fields. The magnetic isolation chamber may comprise magnetic shielding material having a relatively high magnetic permeability (e.g., mu-metal). In one example isolation chamber, multiple, nested layers of high-permeability metal (e.g., Mumetal and/or Hipernom®) are used to provide enhanced magnetic shielding. In certain embodiments, a combination of the above-described methods is used to provide a substantially magnetic field-free environment for calibration of the device 100.

After mounting the device 100 in a substantially magnetic field-free environment, in block 976, a first reading is taken from the magnetic sensor, and in block 978, the first reading is used to determine the sensor offset. In block 980, the device 100 is mounted such that one of the sensor axes is substantially parallel to the undisturbed, local geomagnetic field. In block 982, a second sensor reading is taken, and in block 984, the span along this axis of the sensor is determined from the first and second readings. In block 986, the sensor offset and span for this sensor axis are stored in the device 100, for example, in the boot EEPROM device 610 and/or the nonvolatile storage 614b. In ordinary use, measurements of magnetic field components may be adjusted using the stored sensor offset and span to provide more accurate and precise measurements. For example, an adjusted sensor reading may be determined as (sensor reading—sensor offset)/span.

In embodiments utilizing two- or three-axis magnetic sensors, blocks 974-978 depicted in FIG. 9B can optionally be repeated for each axis to determine a corresponding sensor offset. Similarly, blocks 980-984 can optionally be repeated for each axis to determine a corresponding sensor span. For example, in one embodiment, blocks 974-984 are repeated three times to measure offset and span for each axis of a three-axis magnetic sensor. In block 986, the offset and span measured for each axis of the sensor are stored in the device 100 (e.g., in the boot device 610 or in the nonvolatile memory 614b).

Although certain example calibration methods are described above, an artisan will recognize that the gravity and magnetic sensors 604, 606 as well as other components of the device 100 (e.g., the audiovisual and/or I/O ports) may be calibrated (or checked for proper functioning) prior to distribution of the device 100 to the user. Moreover, sensor characteristics in addition to (or instead of) sensor offset and span may be measured. For example, sensitivity of a sensor over a suitable range of values (e.g., field strengths, accelerations, angles) may be measured. Also, static and dynamic properties of the sensors may be measured. Additionally, an artisan will recognize that various calibration methods (or instructions relating thereto) that are capable of being performed by a user may be provided (e.g., calibration and/or adjustment of the sight 120, the display 132, clocks, etc.).

In some implementations, some or all of the calibration processes may be automated, in whole or in part. For example, in one implementation, the device 100 is coupled to a calibration processor (e.g., a general or special purpose computer) via a suitable wired or wireless connection (e.g., via one or more I/O ports such as the serial port 172). The calibration processor can control some or all of the calibration actions. In some embodiments, the calibration processor (or other data storage device) stores a record or log of the calibration session, which beneficially may be used for quality control purposes. In other implementations, calibration software or applications are provided on a flash memory card capable of being coupled to the nonvolatile memory port 164 (or other suitable port). A benefit of some of these implementations is that external equipment (e.g., the calibration processor) and connections (e.g., a wired serial connection) are not used.

### Celestial Object Identification and Location

As has been described, the device 100 can be used to identify and/or locate celestial objects. As used herein, the term “identify” is a broad term and means that an electronic processing unit (e.g., the control system 600 of the device 100) determines a suitable candidate object in the general direction toward which the device 100 is aimed. Also, as used herein, the term “locate” is a broad term and means that an electronic processing unit (e.g., the control system 600 of the device 100) determines directional information indicating how or where to move and/or orient the device 100 so that it points generally toward a desired or target object.

Certain embodiments of the device 100 are capable of identifying and/or locating celestial objects such as, for example, planets, asteroids, satellites, stars, constellations, asterisms, supernovae, galaxies, nebulae, and quasars. In certain embodiments, the device 100 is configured to identify and/or locate man-made orbiting satellites including, for example, the Hubble Space Telescope and the Space Shuttle. Information related to the celestial objects may be provided in one or more celestial object databases, which may be accessible via the storage 614 and/or 616 of the control system 600 (see FIG. 6). One example database commercially available from Meade includes data related to over 5,000 galaxies, nebulae, and star clusters of all types from the Index Catalog (IC); almost 8,000 galaxies, nebulae, and star clusters of all types from the New General Catalog (NGC); over 100 objects from the Caldwell Catalog of the best objects for small telescopes; over 100 Messier (M) objects; almost 17,000 double stars, variable stars, and other stars of special note from the Smithsonian Astrophysical Observatory (SAO) catalog; about 50 Earth-orbiting satellites; over 25 asteroids, including all of the brightest asteroids; about 15 periodic comets; and all the major planets from Mercury to Pluto as well as many of their satellites. Object databases can be updated and/or upgraded. For example, a new database can be downloaded over a data network such as the Internet (e.g., via the I/O ports 172, 176) or provided on a flash memory card accessible by the control system 600 via the nonvolatile memory port 164.

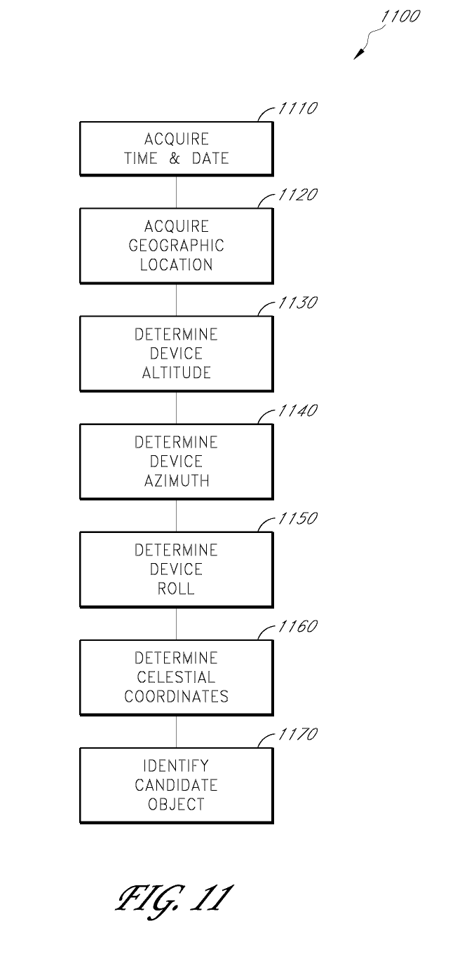

FIG. 10 schematically illustrates one possible method by which a user 1000 can utilize the sighting device 100 to identify (and/or determine information related to) a desired celestial object 1010. The identity (and other properties) of the celestial object 1010 initially may be known or unknown to the user 1000. In this example method, the user 1000 holds the device 100 and aims it toward the object 1010, using the sight 120 to assist aiming. When the object 1010 is suitably centered in the sight 120, the user 1000 actuates the trigger 160, and in response, the control system 600 determines the identity of the object 1010 (discussed further below). In certain embodiments, the device 100 may output information related to the object 1010, e.g., by displaying text, graphics, images, and/or videos on the display 132 and/or by outputting speech, sounds, and/or music to the speaker 152 and/or headphone jack 168. In certain embodiments, the device 100 need not remain pointed toward the object 1010 in order for the object information to continue to be output. Such embodiments advantageously allow the user to move or reorient the device 100 in order to better view and/or hear the information. Additionally, the device 100 may be handed to another observer while the information is being output.

In some embodiments, the device 100 is capable of outputting a light beam (e.g., a laser beam) aimed toward the desired object (or other suitable object). The light beam advantageously may be used to indicate the location of the desired object to the user and/or other nearby observers.

The device 100 advantageously may be sufficiently lightweight that the user 1000 can comfortably hold and aim the device 100 with one hand. Of course, the user 1000 may use two hands to hold the device 100, which may improve aiming stability for some users. Depending on the user's personal preferences, the device 100 may be held relatively close to the user's body or at arm's length.

The device 100 has additional advantages compared to aiming devices or scopes that comprise optical elements such as glass plates or lenses. These optical elements reflect and attenuate light from celestial objects, which can make it very difficult for an observer to see a target object while trying to aim the scope. Additionally, many such aiming scopes have illuminated reticles, which can further interfere with a user's view. Many embodiments of the device 100 (e.g., those that are generally similar to the devices depicted in FIGS. 1A-6) have no optical elements that can interfere with the view of the night sky. Accordingly, such device embodiments can easily be pointed toward any suitable celestial object. Moreover, such device embodiments may be sturdier than aiming scopes having sensitive glass elements.

In embodiments in which the sight 120 comprises the forward 124 and rearward sights 128 (e.g., substantially as shown in FIGS. 1A-6), the user 1000 beneficially can aim the device 100 toward a desired or target object by sighting along the aiming axis 212. The user 1000 can move or otherwise orient the device 100 until the desired object appears to be positioned behind or adjacent to the forward sight 124. The device 100 is properly aligned when the forward sight 124 appears to the user 1000 to be substantially centered between the aiming indicators 128a and 128b. The user 1000 may then actuate the trigger 160, and the control system 600 will proceed to identify the object 1010. As described above, embodiments of the device 100 may be configured to provide different functionalities depending on how the user 1000 actuates the trigger 160. For example, a “single-click” may cause the control system 600 to identify the object, and a “double click” may additionally (or optionally) cause the control system 600 to communicate object information to a telescope control system.

As is well known, the position of celestial objects relative to the celestial sphere may be determined in terms of a celestial coordinate system. The most widely used celestial coordinate system measures celestial object position in terms of right ascension (RA) and declination. As described above, the orientation of the device 100 may be determined in terms of a device coordinate system, such as the altitude, azimuth, and roll system described with reference to FIG. 7A. The pointing direction of the device 100 (e.g., the direction of the aiming axis 212 or the longitudinal barrel axis 208) can be determined in terms of only two angular coordinates (e.g., altitude and azimuth), although some embodiments additionally utilize roll.

In order to identify, locate, and/or track a celestial object, measurements taken in the device coordinate system (e.g., altitude and azimuth) are converted or transformed into celestial coordinates (e.g., right ascension and declination). Alternatively, celestial coordinates may be converted or transformed into device coordinates. Because the Earth rotates about its axis, the celestial sphere appears to rotate once per sidereal day. Additionally, the viewable portion of the celestial sphere depends on the observer's position on the Earth. Therefore, the conversion or transformation between device coordinates and celestial coordinates (or vice-versa) depends on sidereal time, date, and geographic position (e.g., longitude and latitude). A skilled artisan will recognize that many possible algorithms may be used to perform the conversion or transformation between coordinate systems.

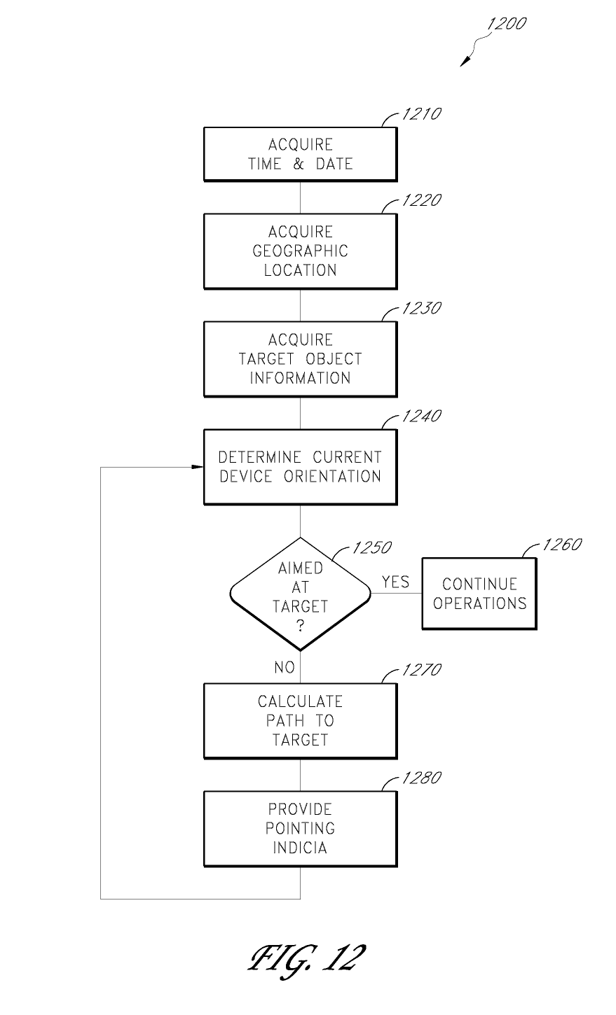

FIG. 11 is a flowchart that schematically illustrates an example method 1100 for identifying a celestial object with the device 100. In blocks 1110 and 1120, time and date and geographic location data are acquired by the control system 600. In some embodiments, the user can manually input the local time/date and/or the local geographic location (e.g., longitude and latitude) into the device 100 via an input unit such as the keys 136. Local geographic information may be input once and stored in nonvolatile memory (e.g., the boot device 610 or nonvolatile memory 614b) for later use. In embodiments utilizing the satellite navigation module 622, local time/date and geographic location can be automatically be entered accurately and precisely based on received satellite signals (e.g., GPS). In other embodiments, an internal clock provides the time. In one embodiment, geographic data for a large number of cities, towns, and/or postal codes (e.g., zip codes) is provided in an internal database. The user can scroll through the database (e.g., via the keys 224-228a) and select the nearest city or town or the appropriate postal code (e.g., via the enter key 230) to provide the control system 600 with an estimate of the user's geographic location. In some embodiments, the device 100 is capable of receiving time, date, and/or geographic location information from another system such as, for example, a telescope control system, a computer system, a cell phone, a PDA, etc. Other methods can be used to enter time and geographic location data including, for example, various techniques further described in U.S. patent application Ser. No. 11/110,626, filed on Apr. 20, 2005, titled “Self-Aligning Telescope,” published as U.S. Patent Publication No. 2006-0238860, the entire disclosure of which is hereby incorporated by reference herein.

In blocks 1130 and 1140, the control system 600 determines the altitude and azimuth of the device 100 based on measurements from the gravity sensor 604 and/or the magnetic sensor 606. The determination of altitude and azimuth is described in detail above. In some embodiments, the control system 600 combines the altitude determination from the magnetic sensor 606 with the altitude determination from the gravity sensor 604 to provide a more accurate result.

In optional block 1150, the roll of the device 100 can be calculated. Roll is not needed to determine the device's pointing direction, which is uniquely defined by altitude and azimuth (or equivalents). Roll determination may be advantageously used in some embodiments to permit the display 132 to show images and videos in an “upright” orientation regardless of the roll angle at which the device 100 is held. In some embodiments, roll is calculated using only measurements from the magnetic sensor 606. In other embodiments, roll is calculated only from measurements from the gravity sensor 604. To achieve higher accuracy, certain embodiments combine determinations from both the magnetic and gravity sensors.

In block 1160, the device orientation (e.g., altitude and azimuth) is converted or transformed into celestial coordinates (e.g., RA and declination) to enable identification of a candidate celestial object in block 1170. The coordinate conversions utilize the time, date, and geographic location information acquired in blocks 1110 and 1120. A skilled artisan will recognize that many coordinate conversion algorithms have been published and may be used by the control system 600. Other embodiments of the device 100 may convert celestial coordinates into device coordinates.

The celestial coordinates define where the device 100 is pointed with respect to the celestial sphere. In block 1170, the control system 600 accesses a celestial object database and compares the device position (in celestial coordinates) with candidate object positions stored in the database (also in celestial coordinates). If a unique match is found, the control system 600 has identified the target object. As discussed, the control system 600 may then display audiovisual information related to the identified object on the display 132, speaker 152, and headphone jack 168.

In some cases, a unique match will not be found. For example, certain embodiments of the device 100 have a pointing accuracy of about 1 degree or less. It is possible that several objects in the celestial object database may have coordinates within an angular distance of about 1 degree from the device coordinate direction. Moreover, user aiming error can add to the uncertainty in pointing direction. For example, the user may depress the trigger 160 when the target object is not sufficiently accurately aligned with the device's aiming axis 212. Accordingly, some embodiments of the control system 600 use any of several well-known algorithms to identify a “best” candidate object. For example, the system 600 may select the candidate object closest to the device's celestial coordinates (e.g., having the smallest angular separation), or the brightest of the candidate objects within a predetermined angular distance from the estimated celestial coordinates. In other embodiments, the control system 600 may establish a preference hierarchy wherein, for example, a candidate planet is selected over a candidate star, a candidate star is selected over a candidate nebula, and so forth. The control system 600 may utilize one or more or a combination of the above algorithms to identify the best candidate.

In other embodiments, in block 1170, different algorithms are used to identify the object. For example, in an embodiment, if there are several likely candidates, the control system 600 outputs a list of the candidates (e.g., on the display 132), and the user can select the most appropriate candidate. For example, the candidates may include a star and a galaxy, and the user, knowing that he or she is observing a star, can select the star. In certain embodiments, the control system 600 provides for additional user input or even manual override of the identification actions in block 1170. Other methods can be used to identify remote objects including, for example, various techniques further described in U.S. patent application Ser. No. 11/490,572, filed on Jul. 21, 2006, titled “User-Directed Automated Telescope Alignment,” the entire disclosure of which is hereby incorporated by reference herein.

There are many situations in which an amateur observer would like to know where a desired or target object is located in the sky. For example, an observer may desire to locate the constellations of the Zodiac or a faint planet such as Uranus. In some cases, an observer may wish to know the location of a target object in the sky in order to assist pointing a telescope or binoculars toward the object. Embodiments of the device 100 are capable of providing instructions that direct the user in pointing the device to the location of the object.

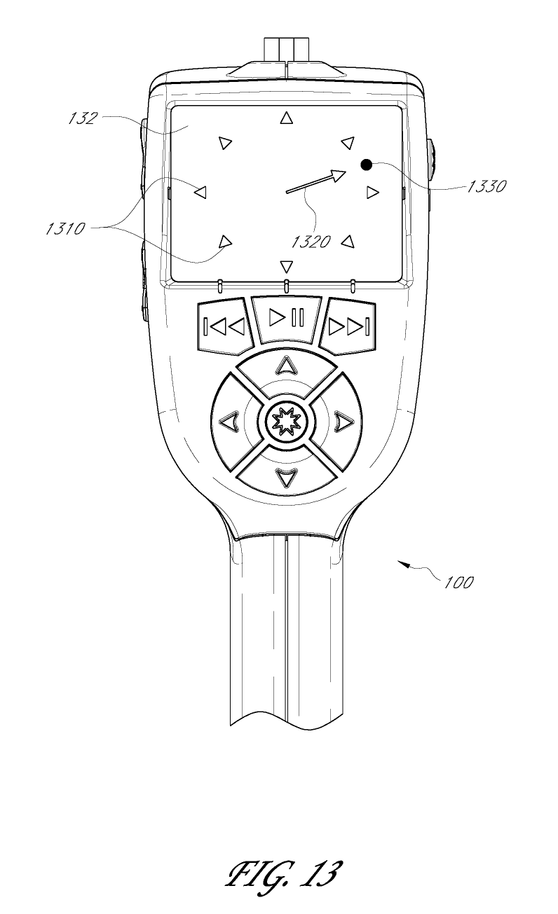

FIG. 12 is a flowchart schematically illustrating one example method 1200 for locating celestial objects with the device 100. In blocks 1210 and 1220, the control system 600 acquires current time date and the geographic position of the device 100. Blocks 1210 and 1220 may be generally similar to blocks 1110 and 1120 of FIG. 11. In block 1230, the control system 600 acquires information on the desired or target object. For example, the user may input identifying information into the device 100 via, e.g., the keys 136. Identifying information can include the name of the object (e.g., “Uranus,” “Orion,” “Arcturus,” “M-31,” etc.) or celestial coordinates (e.g., RA and declination). In some embodiments, a list of interesting objects that are viewable in the night sky (e.g., currently above the horizon) may be shown on the display 132. The user can use the scroll keys 224a-230 to select the target object. The control system 600 may consult a celestial object database to determine the target object's celestial coordinates (e.g., RA and declination).

Manufacturers may offer a “sky tour” that guides an observer to various interesting objects in the night sky. The sky tour may include multimedia content that can be played on the device 100 (e.g., via the display 132 and speaker 152). The sky tour advantageously may include a selection of the “best” objects in the sky for a particular time and geographic location (e.g., “Tonight's Best™” available from Meade). Sky tours (or other suitable target selections) may be provided on flash memory cards, downloaded over the Internet, or available over a wireless data network.

After the target object has been selected, in block 1240 the control system 600 determines the current orientation of the device 100 (e.g., altitude, azimuth, and roll). The determination of device orientation using the gravity sensor 604 and/or the magnetic sensor 606 may be generally similar to that described with reference to blocks 1130-1150 in FIG. 11.

In block 1250, the control system 600 queries whether the device 100 is pointed toward the target object (e.g., the target has been located). In some embodiments of the method 1200, the control system 600 converts or transforms the device coordinates for the pointing direction (e.g., altitude, azimuth) into celestial coordinates (e.g., RA and declination). The system 600 compares the celestial coordinates for the pointing direction of the device 100 to the celestial coordinates for the target object. If the coordinates match (or are within a pointing tolerance), the system 600 assumes that the device 100 is properly aimed at the target object, and the method 1200 continues with further systems operation in block 1260. For example, the device 100 may begin playing audiovisual content related to the target object or may output a light beam (e.g., a laser beam) toward the object. In some embodiments, the pointing tolerance is about ±1 degree of arc. In other embodiments, the pointing tolerance is about ±0.5 degrees in altitude and about ±1 degree in azimuth.

Returning to block 1250, if the system 600 determines that the device 100 is not pointed at the target object, the method 1200 continues in block 1270 in which the system calculates a path from the device's current pointing direction to the target object. The path may be an angular path and may be selected to have the shortest arclength between the pointing direction and the target object. In some embodiments, the path may be “stair stepped,” because it may be easier for a user to move the device in discrete steps (e.g., “up” in altitude and “over” in azimuth) rather than a continuous arc.

In block 1280, the control system 600 uses path information from block 1270 to provide one or more pointing indicators to the user. The pointing indicators may be audio or visual instructions that tell or show the user where or how to move or orient the device 100 so that it points at the target object. In some embodiments, the pointing indicia include visible lights (e.g., LEDs), audible sounds (e.g., voice commands), or other suitable visual or audible direction indicators. In certain embodiments, tactile indicators (e.g., vibrators) may additionally or optionally be used. In one embodiment, the device 100 outputs a light beam (e.g., a laser beam) that directs the user toward the object. For example, the light beam may sweep from the current pointing direction toward the target direction. In some embodiments, the light beam may encircle or otherwise indicate the target object in order to indicate the target's location to the user.

FIG. 13 is a rear view of an embodiment of the device 100 (e.g., from the perspective of the user) schematically showing examples of pointing indicators capable of directing the user toward the target object. In this example embodiment, directional arrows 1310 are disposed in a circular configuration. Although eight arrows 1310 are depicted, fewer or more can be used, and their spacing and configuration may be different. The directional arrows 1310 provide a convenient reference for directions on the sky. In some embodiments, one (or more) directional arrows 1310 may illuminate, blink, change color, size, and/or shape (or a combination thereof) to indicate the direction in which the user should move the device 100. In certain embodiments, a directional graphic 1330 may be shown on the display 132. In FIG. 13, the directional graphic 1330 comprises a circular dot positioned on the display 132 to indicate the direction of movement of the device. Although the directional graphic 1330 is shown as a circular dot, other graphics may be used. The directional graphic 1330 may blink or be displayed in a different color than other display graphics. For example, in one embodiment, the directional graphic 1330 blinks at a different rate depending on how near or far the device 100 is from being pointed at the target. The direction graphic 1330 advantageously may be used in combination with the directional arrows 1310 to provide more accurate pointing directions (e.g., when the pointing direction is between two adjacent arrows 1310). A pointing arrow 1320 may be shown on the display to provide a strong visual cue to the user on the direction in which to move the device 100. The pointing arrow 1320 may have any suitable shape, size, and/or color. In some embodiments, the arrow 1320 has a length representative of the current angular distance to the object.

The pointing indicators 1310-1330 depicted in FIG. 13 are intended as examples and are not intended to limit the ways in which directional information is displayed to the user. The pointing indicators 1310-1330 may be used singly, in combination, and/or in combination with other visual (and/or audible) indicators. Many possible variations of pointing indicators are contemplated and are within the scope of the disclosure herein.

The direction indicated by some or all of the pointing indicators 1310-1330 will depend on the roll angle at which the device 100 is held by the user. For example, if the user twists his or her hand, the pointing indicators 1310-1330 preferably should adjust orientation so as to continue to indicate the directional path to the target object. Embodiments in which the control system 600 determines roll of the device 100 (e.g., via the gravity and/or magnetic sensors 604, 606) advantageously can use the roll information to adjust the orientation of the pointing indicators 1310-1330 to continuously point toward the target object irrespective of how the user is holding or orienting the device 100. Additionally or alternatively, roll indicators (e.g., the roll indicators 750, 760 shown in FIG. 7B) may be displayed to indicate to the user how to hold the device 100 in a substantially level position (e.g., with zero roll).

### Terrestrial Object Identification and Location

Embodiments of the sighting device 100 may be configured to identify and/or locate terrestrial objects instead of, or in addition to, celestial objects. The functionality described above for celestial object identification and/or location advantageously can be modified to provide terrestrial functionality. The device 100 can have many uses. For example, a hiker may carry the device 100 and point it toward objects such as geologic structures, landmarks, monuments. The control system 600 of the device may identify the object, and audiovisual information related to the object may be played (e.g., on the display 132 and/or speaker 152). The device 100 may be used as a navigation tool as well. The hiker may point the device 100 toward a desired destination, and the control system 600 can identify the destination and calculate the line-of-sight distance, shortest path, estimated time of arrival, etc. The device 100 can also assist users navigate in and around cities and towns. For example, a tourist may use the device 100 to identify buildings, structures, and landmarks and/or to determine a suitable route to a distant object. A tourist (or the hiker) may also use the device 100 to locate the position of geologic or man-made features, structures, landmarks, etc. Advantageously, the magnetic sensor 606 enables the device 100 to act as a powerful compass. In embodiments having satellite navigation functionality, the device 100 can be used to determine an accurate location of the user, and additionally maps or other information (e.g., speed and direction of travel) can be shown on the display 132.

Although several examples of the terrestrial use of the device 100 have been described (e.g., hikers and tourists), these examples are intended to be illustrative and non-limiting. Other uses and features are possible. The device 100 may be used inside buildings or structures, for example, within an art museum to identify and provide multimedia content related to the museum holdings.

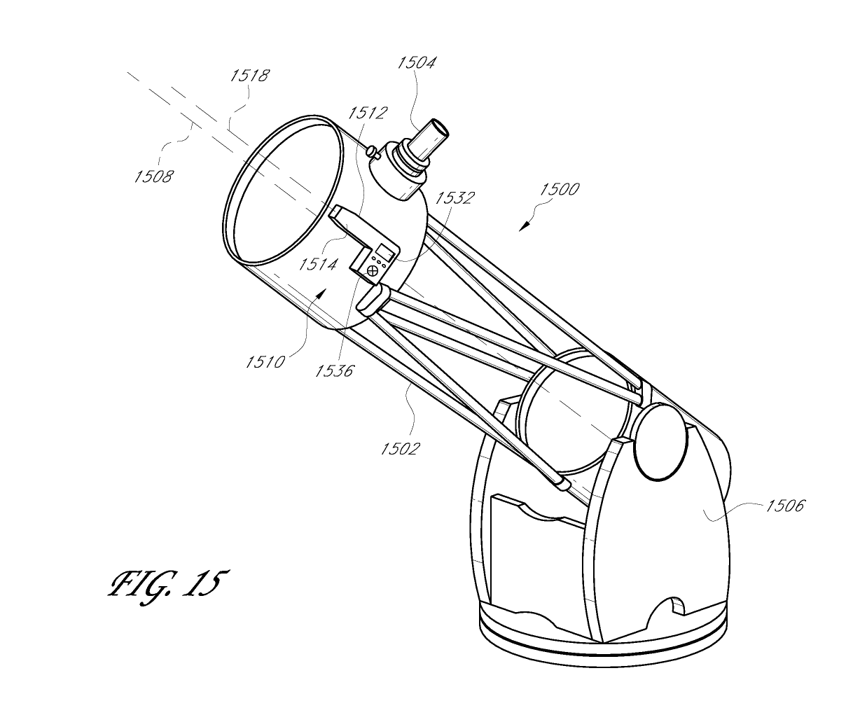

FIG. 14 is a flowchart schematically illustrating an example method 1400 for identifying remote terrestrial objects with the device 100. In block 1410, the control system 600 acquires time and date information, for example, by using methods generally similar to those described with reference to block 1110 of FIG. 11. Block 1410 optionally is not performed in some embodiments, because time information is less important for terrestrial objects than it is for celestial objects, which appear to rotate about the Earth. In block 1420, the geographic location of the device 100 is acquired by the control system 600. Geographic location information may be acquired generally similarly as described with reference to block 1120 in FIG. 11. Certain embodiments of the device 100 advantageously include the satellite navigation module 622, which provides accurate and precise geographic location information to the control system 600.

In block 1430, the control system 600 determines orientation of the device 100. As described above, the control system 600 may utilize measurements from the gravity sensor 604 and/or the magnetic sensor 606 to determine device orientation, for example, altitude, azimuth, and (optionally) roll. In block 1440, the control system 600 identifies a candidate object in the direction toward which the device 100 is oriented. In some embodiments, terrestrial object information is stored in a terrestrial database (e.g., in storage 614, 616) or is accessed via wired or wireless techniques over a data network (e.g., the Internet). The terrestrial database may be upgraded and/or updated, for example, by downloading over the Internet or by purchasing flash memory cards. In some embodiments, a flash memory card may store an updated terrestrial object database, maps of selected geographic regions, and/or listings of interesting attractions, accommodations, restaurants, and other services.

The terrestrial object database may include position data for a range of interesting terrestrial objects. The position data advantageously may include three-dimensional positions. The position data may be stored in any suitable reference system, for example, Cartesian coordinates or any form of map coordinates or map projections. Topographic information may be provided. In some embodiments, position data is stored as longitude, latitude, and elevation. The identification process in block 1440 may determine candidate terrestrial objects by calculating which terrestrial objects in the database are intersected by a ray extending from the geographic location of the device (determined in block 1420) along the pointing direction of the device (determined in block 1430).

Certain embodiments of the device 100 are capable of locating terrestrial objects and providing audible and/or visible directions that direct the user how to move or aim the device 100 toward the object. In certain such embodiments, the device 100 provides visible pointing indicia to the user that may be generally similar to those depicted in FIG. 13. P Manufacturers may offer a “terrestrial tour” (analogous to the “sky tour” described above) that guides a user to various interesting objects located within the observable horizon. The terrestrial tour may include multimedia content that can be played on the device 100 (e.g., via the display 132 and speaker 152). Terrestrial tours (or other suitable target selections) may be provided on flash memory cards, downloaded over the Internet, or available over a wireless data network.

### Control Systems for Optical Devices

Embodiments of the device 100 can be used in a wide variety of applications. For example, the device 100 may be configured to perform some or all of the functions of a controller for an optical system such as a telescope. Although some of the following examples will be described in the context of a telescope system, the present disclosure is not limited thereto, and in various embodiments, the device 100 can be used with any other optical system including, for example, binoculars, spotting scopes, solar telescopes, laser systems, satellite dishes, solar collectors, etc.

In one embodiment, the device 100 acts as a “remote viewfinder” for a telescope having a motorized mount operable by a controller (such as the Meade Autostar or Autostar II controllers). The device 100 is configured to communicate with the controller. For example, a cable can be connected between the serial port 172 of the device 100 and a serial port of the controller. In other embodiments, a USB, FireWire®, or other suitable wired connection is used. In some embodiments, the device 100 is capable of wireless communication with a controller having wireless capability. In some wireless embodiments, a “handshaking” procedure may be used to establish communication between the device 100 and one (or more) selected telescope controllers. An advantage of the handshaking procedure is that commands communicated wirelessly by the device 100 will cause only the selected controllers to take action, rather than all wireless-enabled controllers within the range of the device 100 (e.g., all other wireless telescopes in a “star party”).

FIG. 10 schematically illustrates an example in which a user 1000 points the device 100 toward a target or desired object 1010. In this example, the device 100 is in wireless communication with a telescope controller 1022 configured to control movement and/or orientation of an optical axis 1024 of a telescope system 1020. When the device 100 has been sufficiently accurately aimed at the target object 1010, the user can actuate the device trigger 160 (or other suitable input element), and the control system 600 communicates the location of the object 1010 to the telescope controller 1022. For example, the location may be provided as celestial coordinates (e.g., RA and declination), which the controller 1022 converts to telescope device coordinates. If the control system 600 and the telescope controller 1022 utilize inter-compatible operating systems, the control system 600 may communicate location information in the form of device coordinates (e.g., altitude and azimuth). Upon receiving the location of the desired object 1010, the telescope controller 1022 can direct (or otherwise actuate) the telescope drive motors to slew the optical axis 1024 of the telescope system 1020 toward the object 1010, as schematically illustrated by directional arrow 1028.

As described herein, some embodiments of the device 100 provide the user with a range of options after locating an object. For example, by “single-clicking” the trigger 160, the user may play multimedia content related to the object. By “double-clicking” the trigger 160, the user may communicate object location information to the controller of a telescope, which may perform an associated action (e.g., playing multimedia content on its own display) without slewing the telescope. By “triple-clicking” the trigger 160, the user may communicate the location information and command the controller to slew the telescope toward the desired object. In some embodiments, the actions taken by the control system 600 upon actuation of the trigger 160 may be user-settable or user-selectable. Many variations are possible.

In the above-described embodiment, the device 100 acts as a “master” and the telescope controller acts as a “slave.” In other embodiments, the telescope controller may act as the master, while the device 100 acts as the slave. For example, an observer can actuate the controller to communicate object location information to the sighting device 100. In response, the device 100 may actuate directional indicators (e.g., as depicted in FIG. 13) showing the device user how to move or otherwise orient the device toward the object. In certain embodiments, bidirectional communication may be established between the device 100 and the telescope controller, thereby permitting either to act as the master.

In some embodiments, the device 100 is used in part to control movement and pointing of a light-emitting optical system. In one such implementation, the optical system comprises a lighting unit configured to direct a light beam toward remote objects (e.g., celestial and/or terrestrial objects). The light beam of the optical system may be pointed or directed toward different objects in any suitable manner. For example, the lighting unit may be attached to a motorized drive system capable of moving and/or orienting the unit (and the emitted light beam) in one, two, or three dimensions. In other implementations, one or more optical elements (e.g., lenses, mirrors, gratings, beamsplitters, spatial light modulators, etc.) may be used to redirect the light beam toward a suitable direction. In certain embodiments, a combination of optical and mechanical techniques is used to point the light beam. In some embodiments, the lighting unit comprises a laser (e.g., a “green light” laser as described above), and the emitted light beam comprises a laser beam. The device 100 may be configured to communicate with the light-emitting optical system by wired and/or wireless methods. In one possible example of use, the user points the device 100 toward a target object and actuates the trigger 160. The control system 600 of the device 100 communicates target location information to the light-emitting optical system, which directs the emitted light beam toward the target object. Any number of nearby observers can view the emitted beam. An advantage of such embodiments is that the user can lead a group of observers (e.g., a star party, a class of students) on a tour of celestial (and/or terrestrial) objects by using the device 100 to control pointing of the emitted light beam.

In some implementations, the optical system is configured so that the emitted light beam can be turned off, interrupted, and/or redirected. For example, the optical system may comprise an optical shutter that interrupts the light beam for a time interval. Such implementations are advantageous because the light beam may be substantially prevented from intercepting (or reflecting into or onto) objects such as for example, nearby persons (e.g., a person's eyes) or passing aircraft. By suitably turning off (or interrupting or redirecting) the light beam, likelihood of possible damage (or perceived damage) by the beam can be reduced.

In some embodiments, the device 100 is capable of providing a suitable command to the optical system to take suitable action to turn off, interrupt, or redirect the light beam. For example, in one possible example of use, the user of the device 100 may notice that an overhead aircraft or a nearby person is approaching the vicinity of the light beam. By suitably actuating the trigger 160, an “interrupt” command can be communicated to the optical system, which turns off (or interrupts or redirects) the light beam, thereby preventing possible or perceived damage by the beam. When the object has moved away from the vicinity of the beam, the user may suitably actuate the trigger 160 to provide a command for the optical system to resume emitting light toward the target object.

Although advanced telescope systems have become increasingly automated and have computerized controllers capable of directing motorized telescope mounts, many older telescope systems and “starter” telescope systems do not have computerized controls and/or motorized mounts. Some amateur astronomers become frustrated with the difficulty of locating celestial objects for subsequent viewing through the telescope. Because embodiments of the device 100 are capable of locating celestial objects, they advantageously can be used to assist the user in pointing the telescope toward desired objects, thereby making it easier for novices to enjoy astronomical observing.

Accordingly, embodiments of the sighting device 100 can be configured to act as telescope controllers for non-motorized and/or non-computer-controlled telescope systems. FIG. 15 is a perspective view schematically illustrating a telescope system 1500 comprising a telescope 1502 mounted in a telescope mount 1506. The depicted telescope 1502 is a Newtonian telescope and has an optical axis 1508. However, the telescope 1502 may be any other type of telescope including, for example, a refractor, a Cassegrain telescope, or a catadioptric telescope such as a Schmidt-Cassegrain or a Maksutov. The telescope 1502 typically includes an eyepiece 1504 or some other viewing or imaging apparatus (e.g., a digital camera). The mount 1506 shown in FIG. 15 is an alt-azimuth mount, but equatorial (polar) mounts or any other type of telescope mount may be used.

The telescope system 1500 shown in FIG. 15 is commonly known as a Dobsonian system and is commercially available from Meade as a LightBridge™ telescope. Dobsonian systems advantageously can have a large optical aperture and be made relatively inexpensively. Dobsonian systems disadvantageously do not typically have a computerized telescope controller that can automatically point the telescope to a desired object. A sighting device 1510 advantageously may be attached to the telescope 1502 and used to locate desired objects.

The sighting device 1510 may be generally similar to the sighting device 100 illustrated in FIGS. 1A-5. The embodiment depicted in FIG. 15 comprises a housing 1512 that comprises a barrel 1514. An aiming axis 1518 is generally parallel to a longitudinal axis of the barrel 1514. Control system electronics can be disposed within the housing 1514. The control system electronics can be generally similar to the control system 600 described with reference to FIG. 6. For example, the control system electronics of the device 1510 may utilize one or more gravity sensors and/or one or more magnetic sensors to determine the orientation of the aiming axis 1518.

The device 1510 comprises a display 1532 and an input unit 1536. The display 1532 can be generally similar to the display 132 and may be used to output text, graphics, images, and/or videos. The display 1532 and the input unit 1536 may be used to communicate inquiries, commands, and data between the user and the device control system. The input unit 1536 comprises a keypad in this embodiment. The device 1510 may include some or all of the components described above with reference to FIGS. 1A-7B. For example, the device 1510 may include I/O ports, speakers, flash card ports, sights, etc.

The device 1510 may be attached, retrofitted, or otherwise mounted to the telescope system 1500 in any suitable fashion. For example, the device 1510 may be attached by mounting rings. In some implementations, the device 1510 is strapped to a portion of the body of the telescope 1502 such as the tube, a truss or strut, or the primary or secondary mirror cell. The device attachment may be via straps, wires or cables, hook-and-loop fastener material (e.g., Velcro®), or any other suitable connector. The device 1510 may be magnetically attached to a metallic portion of the telescope system 1500; however, in such implementations, the magnetic attachment advantageously may be magnetically shielded to reduce interference with any magnetic sensors. Although FIG. 15 depicts the device 1510 attached to the forward end of the telescope 1502, the device 1510 may be attached anywhere else on the telescope 1502 or the mount 1506. Many telescope systems include a finder scope, and the device 1510 may be attached thereto. In some implementations, rather than attaching the device 1510 to the telescope 1502, the device 1510 is simply placed next to a portion of the telescope 1502.

It is advantageous to align the aiming axis 1518 of the device 1510 to be substantially parallel to the optical axis 1508 of the telescope 1502. In some embodiments, the sighting device 1510 comprises optical elements (e.g., lenses, mirrors, oculars) permitting the user to sight along the aiming axis 1518 to check the device's alignment with the optical axis 1518 of the telescope 1502. The user may periodically adjust the device 1510 to improve accuracy of the alignment. In some embodiments, the sighting device 1510 may include optics that permits the user (or other imaging apparatus) to view a field of view along the aiming axis 1518 in order to more accurately center the target object within a field of view along the optical axis 1508 of the telescope 1502. In some implementations, the telescope system 1500 includes a finder scope that may be used to more accurately center the target object after the sighting device 1510 has been used to point the optical axis 1508 toward the vicinity of the target object.

To use the device 1510 as a telescope controller, the user may input identifying information for a target object into the device 1510. For example, the user may enter the information via the input unit 1536 (e.g., via a keypad). In other embodiments, the display 1532 may show a list of possible target objects, and the user can select a desired object from the list. After the device 1510 acquires the target information, the device 1510 may determine the location of the target (e.g., altitude and azimuth) and provide appropriate directional information to the user. The device 1510 may utilize a target location method generally similar to the method 1200 discussed with reference to FIG. 12. The directional information may include visual and/or audible indicators similar to those described with reference to FIG. 13.

Using the directional information, the user (or other observer) can cause the optical axis 1508 of the telescope 1502 to point toward the target object. In the case of unmotorized systems (e.g., the Dobsonian depicted in FIG. 15), the user may push and/or pull on the telescope 1502 (or a portion of its tube) to point the telescope axis 1508. If the telescope mount 1506 comprises axis drive motors (e.g., altitude and azimuth motors or a polar axis motor), the user (or other observer) may actuate the drive motors to position the optical axis 1508. In some implementations, the device 1510 can communicate object location information to a telescope controller that directs the telescope 1502 to point toward the target object. In some of these implementations, target object location and movement of the telescope 1502 toward the object is partially or fully automated. As described above, the device 1510 may output multimedia content related to the target object.

Accordingly, by coupling the sighting device 1510 to the telescope system 1500 (or to any suitable optical system), the user advantageously will have a greater ability to locate celestial objects and control the telescope 1502.

While certain embodiments have been described above, these embodiments have been presented by way of example only and do not limit the scope of the disclosure. Indeed, the novel apparatus, systems, and methods described herein may be embodied in a variety of forms including equivalents and obvious modifications. A skilled artisan will recognize that various omissions, substitutions, and changes in the described embodiments may be made without departing from the scope of the disclosure. Accordingly, the scope of the disclosure herein is to be determined by a fair reading of the appended claims and equivalents thereof.

What is claimed is:

1. A device for identifying or locating an object, said device comprising:
a housing comprising a grip and a barrel, said barrel having a pointing axis and said grip having a grip axis that is non-parallel to said pointing axis, wherein said grip is usable to orient the pointing axis of the barrel toward an object;
a display attached to said housing, said display configured to provide visual output capable of being viewed by a user of the device when the device is pointed at or being pointed at the object;
one or more orientation sensors capable of providing information related to orientation; and
a processor capable of receiving the information from at least one of the one or more orientation sensors and determining an orientation of the pointing axis of the barrel.

2. The device of claim 1, wherein said housing is substantially pistol-shaped.

3. The device of claim 1, wherein an angle between said grip axis and said pointing axis is in a range from about 100 degrees to about 130 degrees.

4. The device of claim 1, wherein an angle between said grip axis and said pointing axis is about 90 degrees.

5. The device of claim 1, wherein a viewing surface of said display is substantially perpendicular to said pointing axis of said barrel when the device is being operated.

6. The device of claim 1, wherein said display comprises a flat panel display.

7. The device of claim 1, wherein the one or more orientation sensors comprises a gravity sensor capable of providing information related to a reference acceleration.

8. The device of claim 7, wherein the reference acceleration comprises the Earth's gravitational acceleration.

9. The device of claim 1, wherein the one or more orientation sensors comprises a magnetic sensor capable of providing information related to a reference magnetic field.

10. The device of claim 9, wherein the reference magnetic field comprises the Earth's magnetic field.

11. The device of claim 9, wherein the orientation comprises a roll angle around the pointing axis.

12. The device of claim 1, further comprising an input device capable of receiving input information or commands.

13. The device of claim 12, wherein the input device is actuatable by the user's finger on a hand used to hold the grip of the device.

14. The device of claim 12, wherein the input device is capable of receiving location information for the object.

15. The device of claim 1, further comprising a satellite navigation module capable of providing information related to a position of the device to the processor.

16. The device of claim 1, further comprising a power source that is substantially magnetically shielded.

17. A method of aiming a device toward an object, the method comprising:
providing a device comprising:
a housing comprising a grip and a barrel, said barrel having a pointing axis and said grip having a grip axis that is non-parallel to said pointing axis,
a sight having an aiming axis that is substantially parallel to said pointing axis;
a display attached to said housing;
one or more orientation sensors capable of providing information related to orientation; and
a processor capable of receiving the information from at least one of the one or more orientation sensors and determining an orientation of the pointing axis or the aiming axis;
pointing the aiming axis of the sight substantially toward the object; and
actuating the processor to determine an orientation direction of the pointing axis or the aiming axis.

18. The method of claim 17, wherein the sight comprises a forward sight and a rearward sight, the forward sight spaced apart from the rearward sight along the aiming axis.

19. The method of claim 17, further comprising illuminating a portion of the sight.

20. The method of claim 17, further comprising:
providing an object database comprising location information for one or more candidate objects; and
comparing the orientation direction to the location information.

21. The method of claim 20, further comprising identifying one or more candidate objects having a location substantially along the orientation direction.

22. The method of claim 21, further comprising outputting on the display information related to at least one of the identified candidate objects.

23. The method of claim 22, wherein the object is a celestial object.

24. A sighting device comprising:
housing means comprising means for sighting toward an object and means for gripping the sighting device, said sighting means disposed nonparallel to said gripping means;
means for outputting visual information, said outputting means attached to said housing means;
means for sensing orientation; and
means for processing information from said sensing means to determine an orientation of the sighting device.

25. The sighting device of claim 24, wherein said sensing means comprises a gravity sensor.

26. The sighting device of claim 24, wherein said sensing means comprises a magnetic sensor.

27. The sighting device of claim 26, wherein the orientation comprises roll of the housing means.
